(19) United States
(12) Patent Application Publication
(10) Pub. No.: US 2014/0340376 A1
(43) Pub. Date: Nov. 20, 2014

(54) DISPLAY DEVICE

(71) Applicants: SONY CORPORATION, Tokyo (JP); SONY COMPUTER ENTERTAINMENT INC, Tokyo (JP)

(72) Inventors: Takeshi Itagaki, Saitama (JP); Masakazu Yajima, Kanagawa (JP); Hideaki Ishioka, Tokyo (JP); Katsuhiko Nakano, Saitama (JP); Takeshi Yamagishi, Kanagawa (JP); Hidetoshi Kabasawa, Saitama (JP)

(21) Appl. No.: 14/344,694

(22) PCT Filed: Aug. 16, 2012
(86) PCT No.: PCT/JP2012/071244

§ 371 Date: Mar. 13, 2014

(30) Foreign Application Priority Data
Sep. 20, 2011 (JP) 2011-204304

(51) Int. Cl. G09G 3/34

(52) U.S. Cl. CPC G09G 3/344; G09G 2330/02; G09G 2354/00; G09G 2360/08; G09G 2380/14
USPC 345/211; 345/107

(57) ABSTRACT

There is provided a display device including a display unit, a power generation unit configured to have one or more power generation mechanisms and to generate electric power necessary for re-writing information displayed on the display unit, and a housing configured to have a substantial flat plate shape as a whole and to accommodate the display unit and the power generation unit. Generation of electric power by at least one power generation mechanism among the one or more power generation mechanisms is associated with an input operation performed by a user.

### TECHNICAL FIELD

The present technology relates to a display device. The present technology relates particularly to a display device equipped with a mechanism that generates power with an action of a user for an input operation, or the like.

### BACKGROUND ART

Instead of printing text on paper, a digital book that displays various kinds of content on a screen as images is known. For example, Patent Literature 1 mentioned below discloses a digital book equipped with a touch screen that senses operations of a user. Such a digital book is advantageous in that it enables a large amount of content to be carried and information search to be simplified.

On the other hand, since a digital book needs electric power to display content or for re-writing, the digital book generally includes a storage battery, or the like as a driving power source. Thus, it is necessary for a user to charge a storage battery before using a digital book, for example, for the user to enjoy the content of the digital book outdoors.

When a storage battery is used as a power source in a digital book, there are cases in which a user is not able to use the digital book as a remaining storage battery level is lowered due to use of the digital book by the user. In addition, when a user does not use a digital book for a long period of time, a remaining level of a storage battery of the digital book is lowered due to self-discharge, and thus the user may not be able to activate the digital book promptly. Since outdoor usage of digital books is expected, it is desirable to enable users to use the digital book without worrying about the remaining level of a battery.

In order to enable usage of electronic equipment even when a remaining storage battery level is lowered, for example, Patent Literature 2 mentioned below discloses a mobile telephone which generates power with impact force made when a cover, which is provided in a main body portion so as to be opened and closed, is opened and closed to compensate electric power. Non-Patent Literature 1 mentioned below discloses a digital book that generates power when a movable portion that is called a flipper provided in a main body portion is flipped.

However, the mobile telephone disclosed in Patent Literature 2 needs an operation that is not directly related to exhibiting a calling function, which is necessary for mobile telephones. Since the digital book disclosed in Non-Patent Literature 1 is provided with the flipper, a size of the screen displaying content is limited. In addition, the shape of the digital book makes it difficult for users to hold the digital book in one hand.

### CITATION LIST

### Patent Literature

Patent Literature 1: Specification of US Patent Application Publication No. 2011/0050594

Patent Literature 2: JP 2002-190627A

### Non-Patent Literature

Non-Patent Literature 1: Nadeem Haidary ‘Portfolio’ 15 Bibliofile [online] NadeemHaidary, 2009. [retrieved on Jul. 6, 2011]. Retrieved from the Internet: <URL: http://nadeemhaidary.com/bibliofile.html>.

### SUMMARY OF INVENTION

### Technical Problem

It is desirable to enable a user to use a digital book without worrying about a remaining level of a storage battery.

### Solution to Problem

According to a preferable embodiment of the present disclosure, a display device has a display unit, a power generation unit, and a housing.

The power generation unit is configured to have one or more power generation mechanisms and generates electric power necessary for re-writing information displayed on the display unit.

The housing is configured to have a substantial flat plate shape as a whole and to accommodate the display unit and the power generation unit.

Generation of electric power by at least one power generation mechanism among the one or more power generation mechanisms is associated with an input operation performed by a user.

According to the embodiment of the present disclosure, the display device includes one or more power generation mechanisms. In addition, power generation by the power generation mechanisms is associated with an input operation performed by a user. The input operation performed by a user is an active movement by the user for instructing switching of images in the display device, and for example, an input operation for page-turning in a digital book, or the like. In other words, the power generation mechanisms perform power generation with an input operation of a user via a user interface of the display device. Electric power obtained from power generation is used to re-write information displayed on the display unit.

In the present disclosure, the power generation mechanisms perform power generation whenever a user performs input operations on the display device. Thus, it is not necessary for the user to charge a storage battery in advance before using the display device. In addition, since power generation by the power generation mechanisms is associated with input operations performed by the user, it is not necessary for the user to perform an operation that is not directly related to demonstration of an original function of the display device at the time of power generation.

In the present specification, a “digital book” is defined as a medium for displaying content rather than content itself. Thus, in the “digital book” referred to in the present specification, various display devices such as information terminals are included. In addition, in the present specification, a “generator” is not limited to a device using an electromagnetic induction phenomenon. Note that, when the present specification simply refers to a “user,” the “user” indicates a person who performs operations on a display device such as a digital book.

### Advantageous Effects of Invention

According to at least one embodiment of the present technology, it is possible to provide a digital book that can be used by a user without worrying about a remaining level of a storage battery.

### BRIEF DESCRIPTION OF DRAWINGS

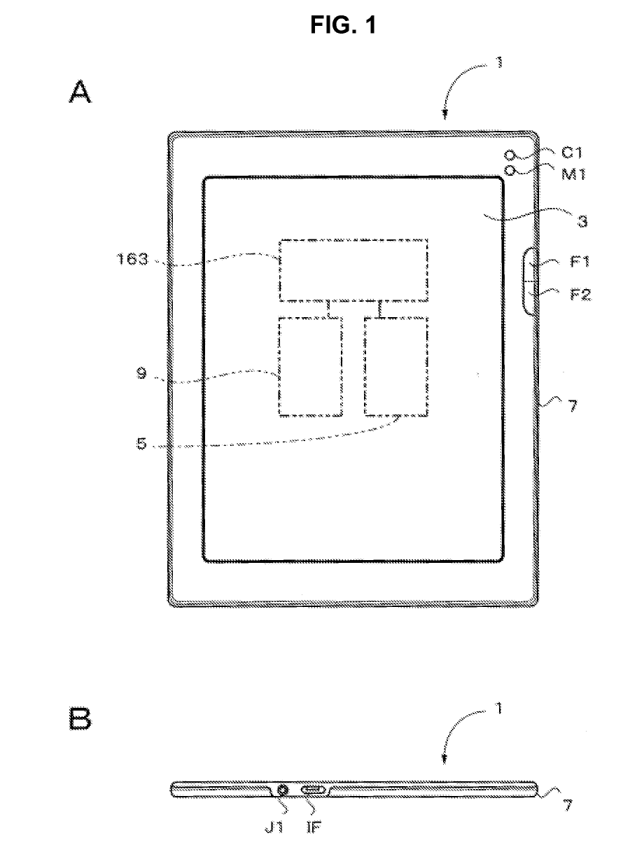

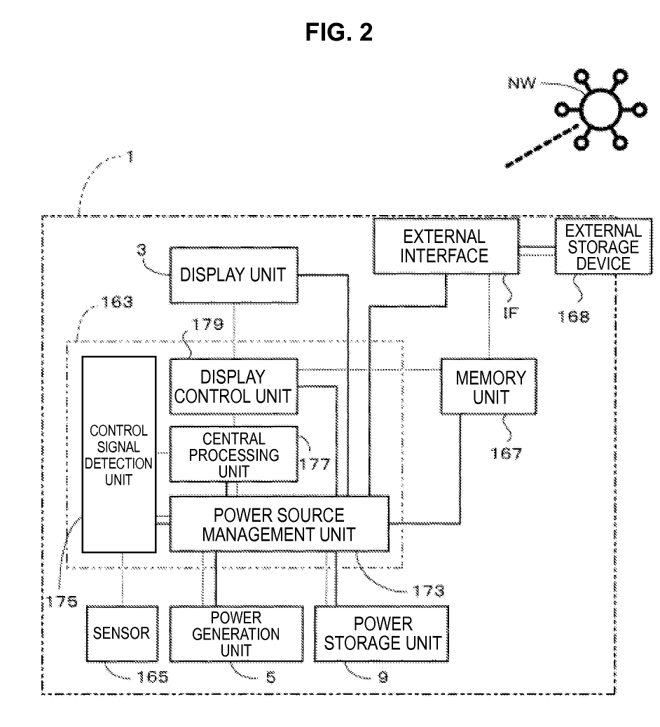

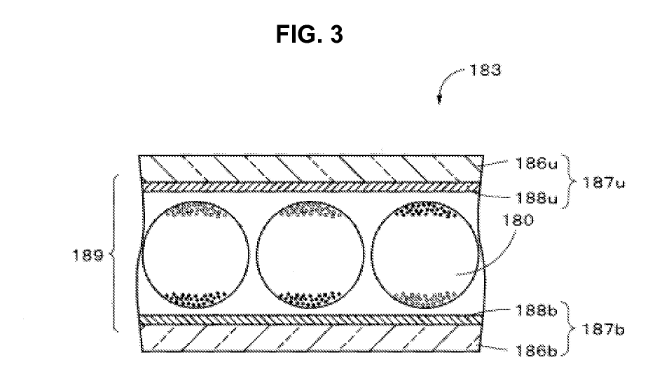

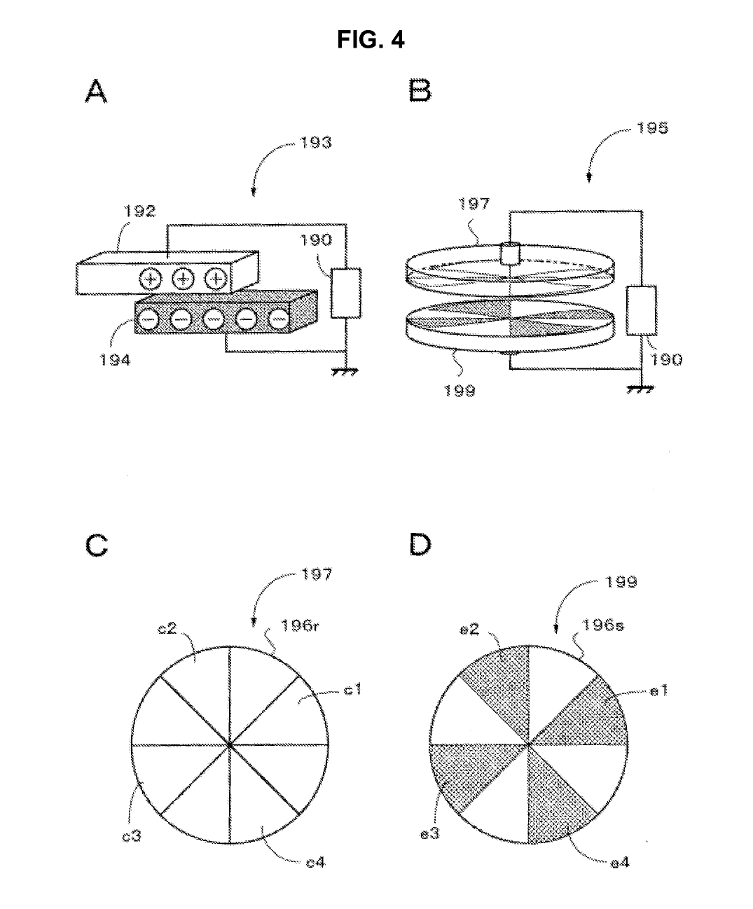

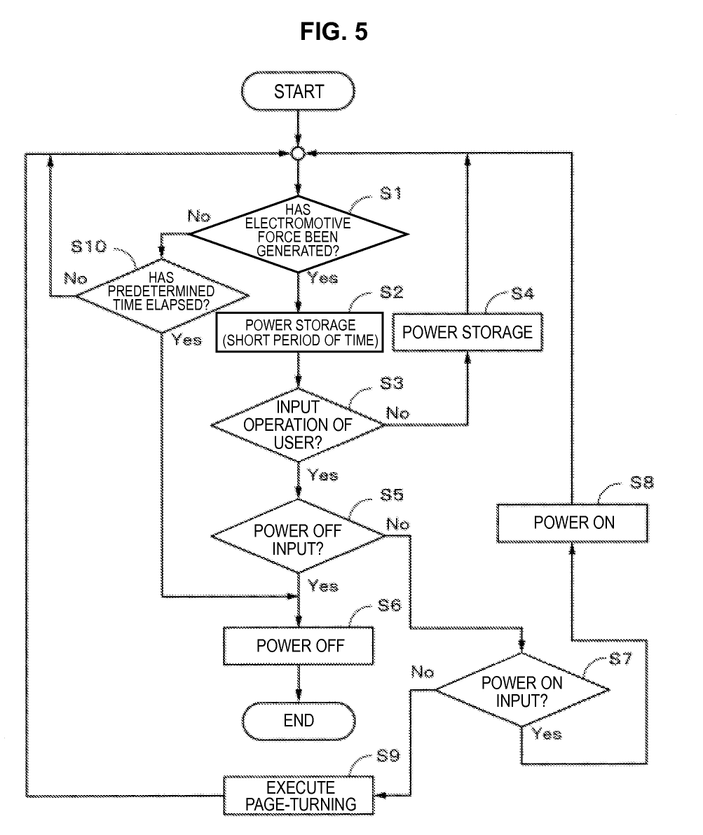

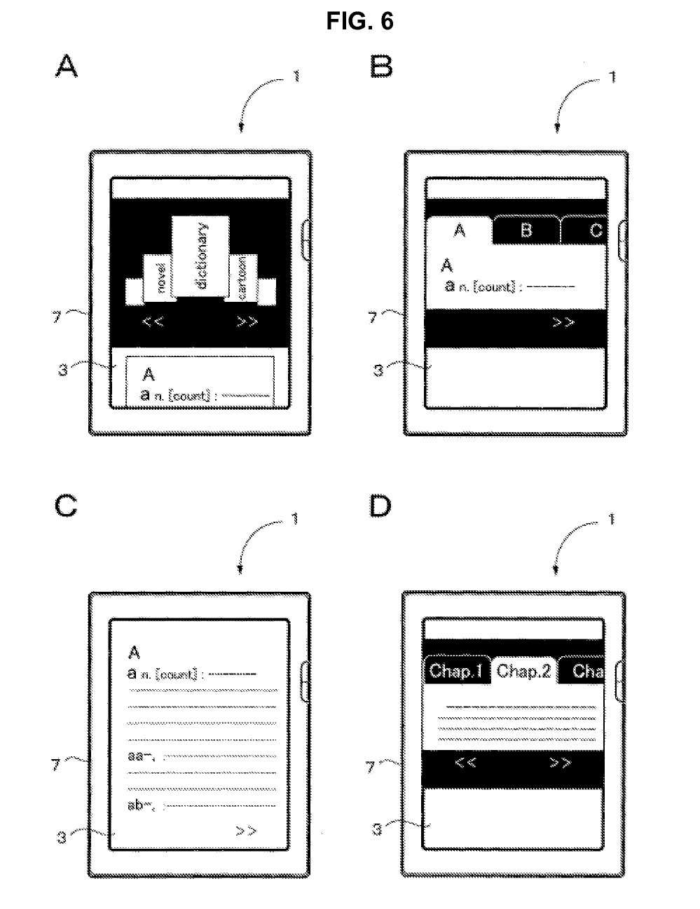

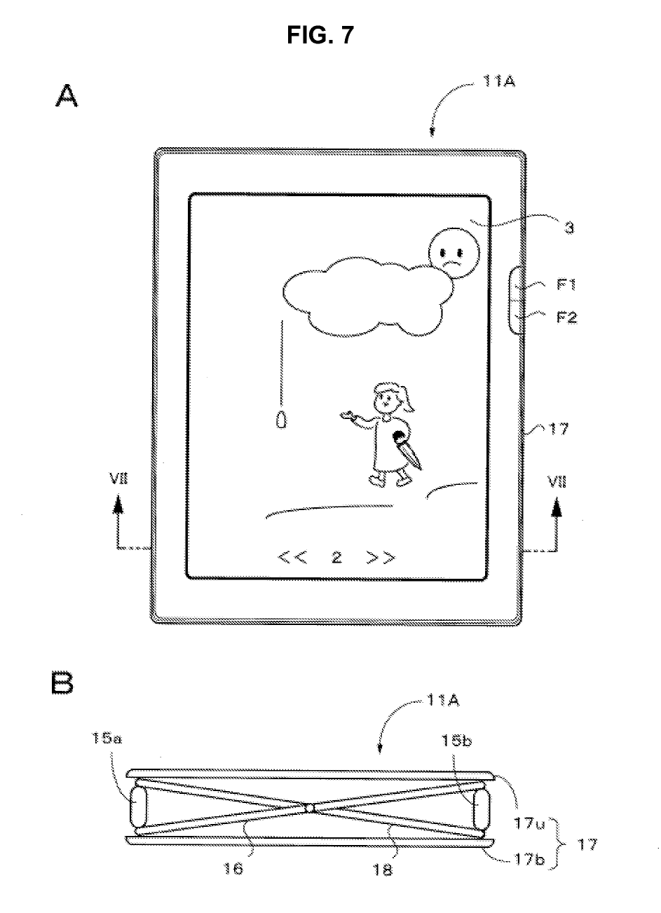

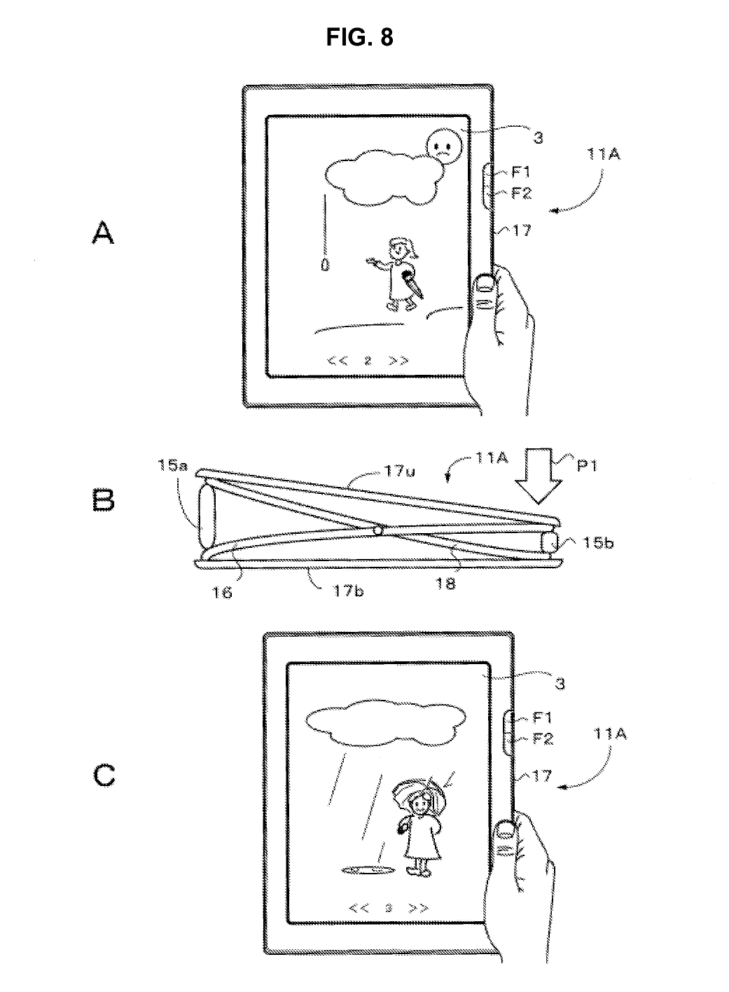

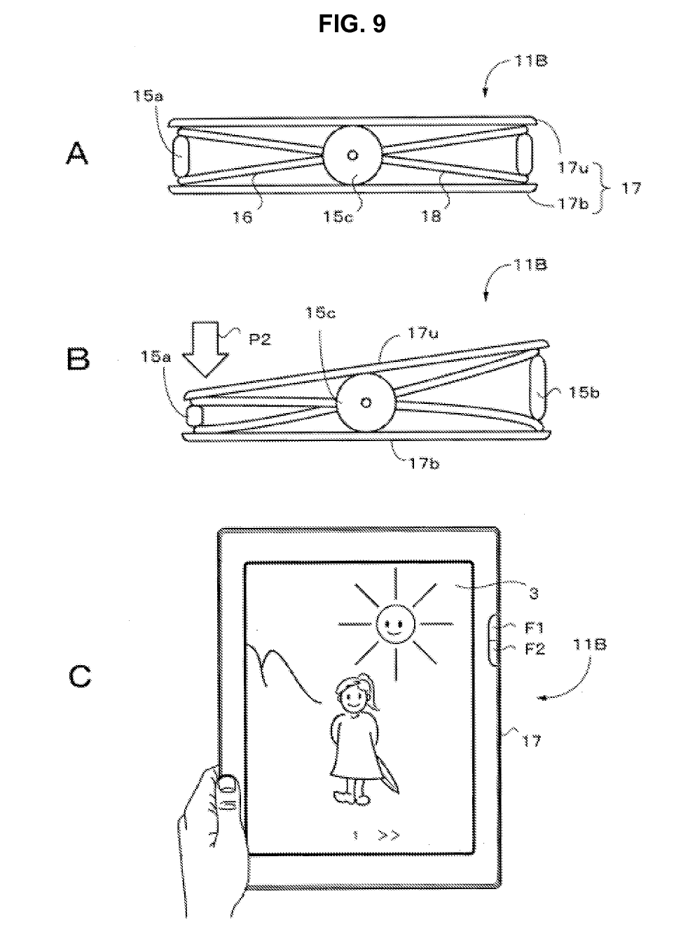

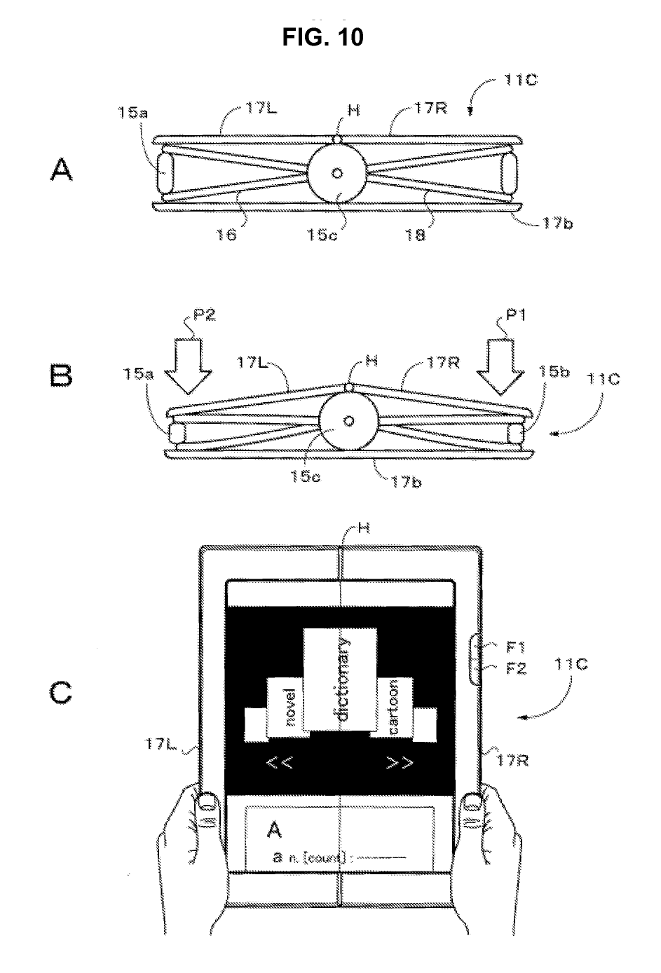

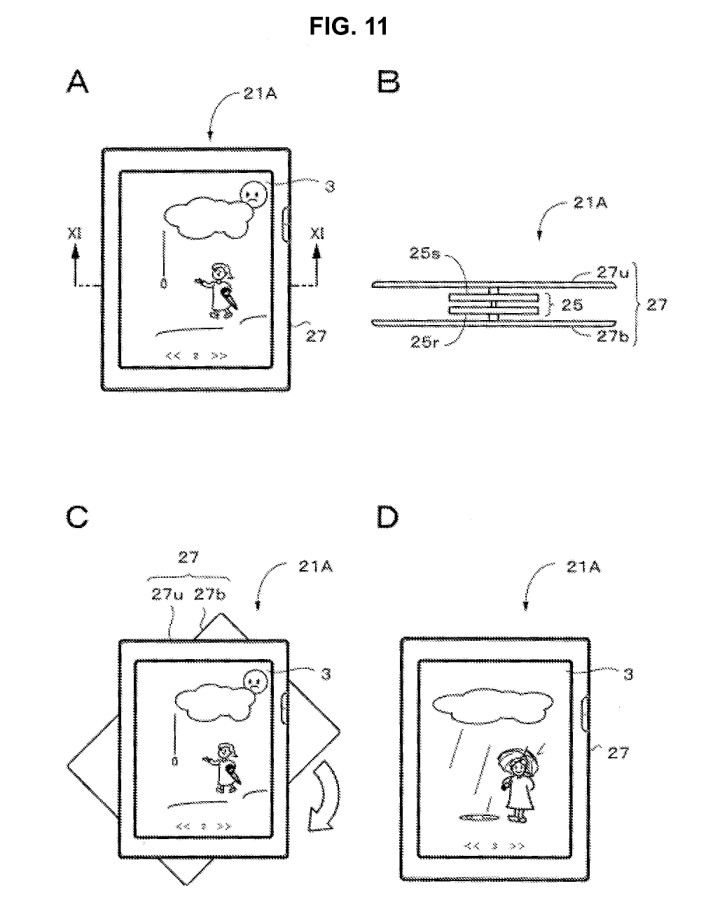

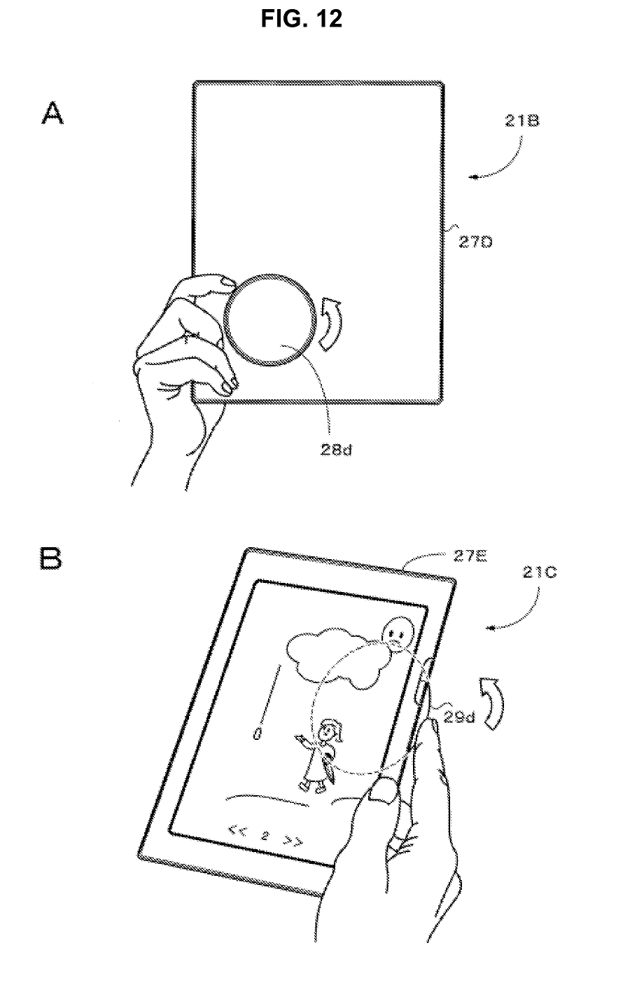

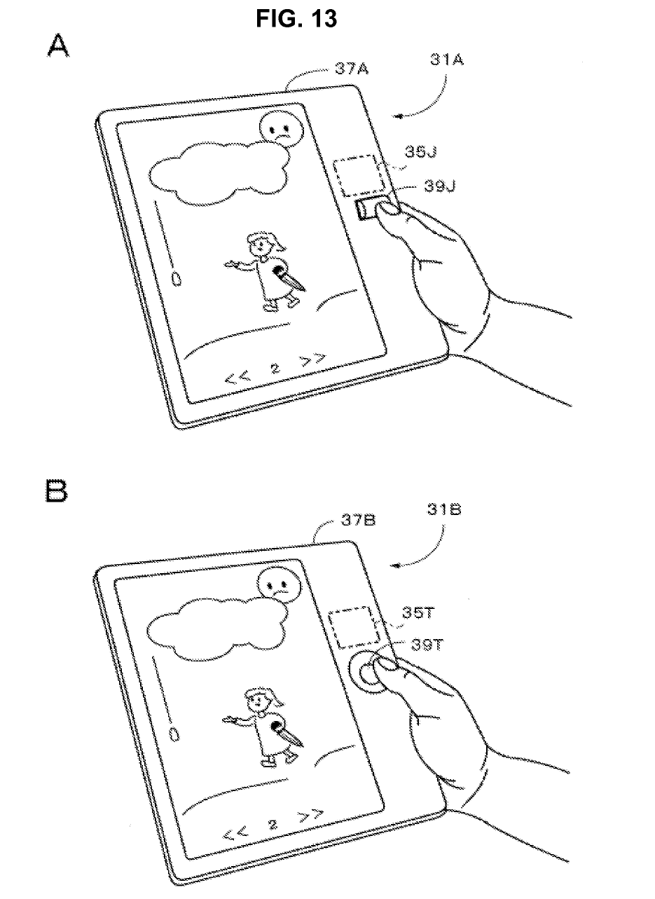

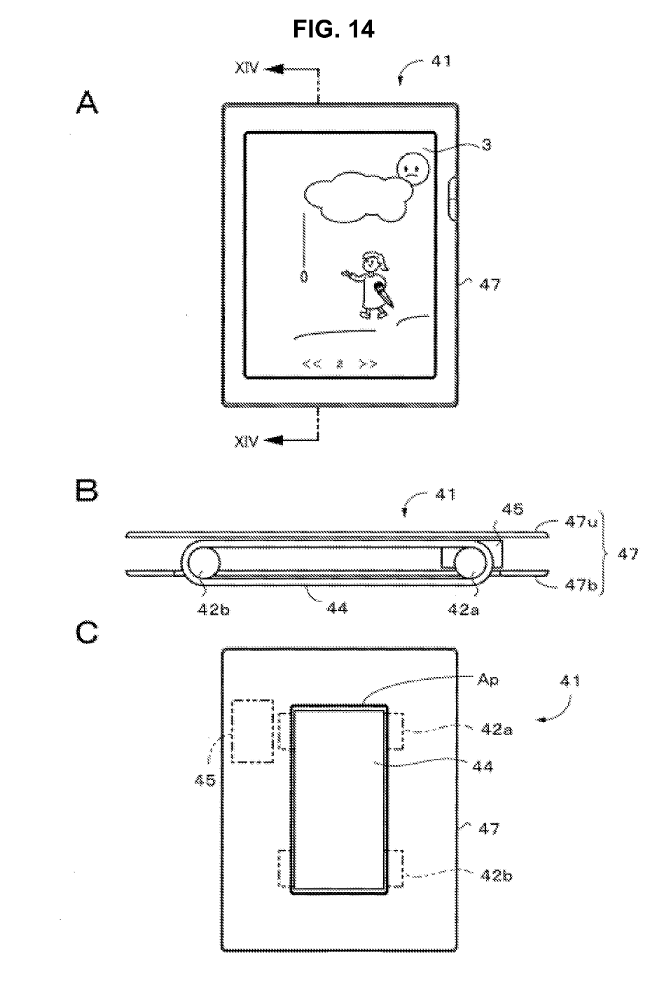

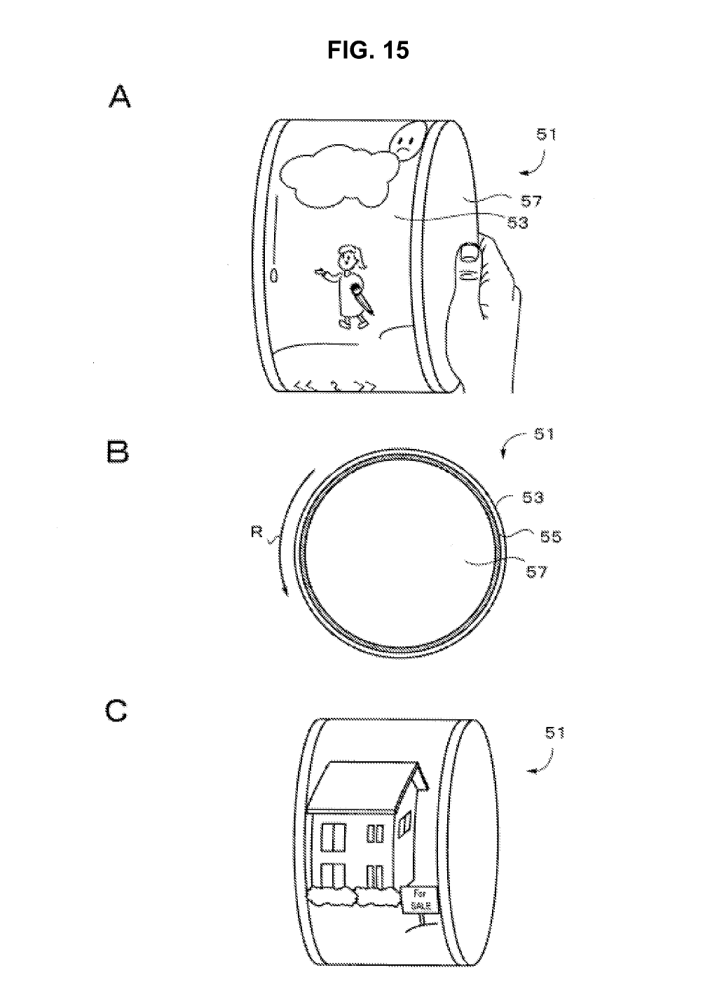

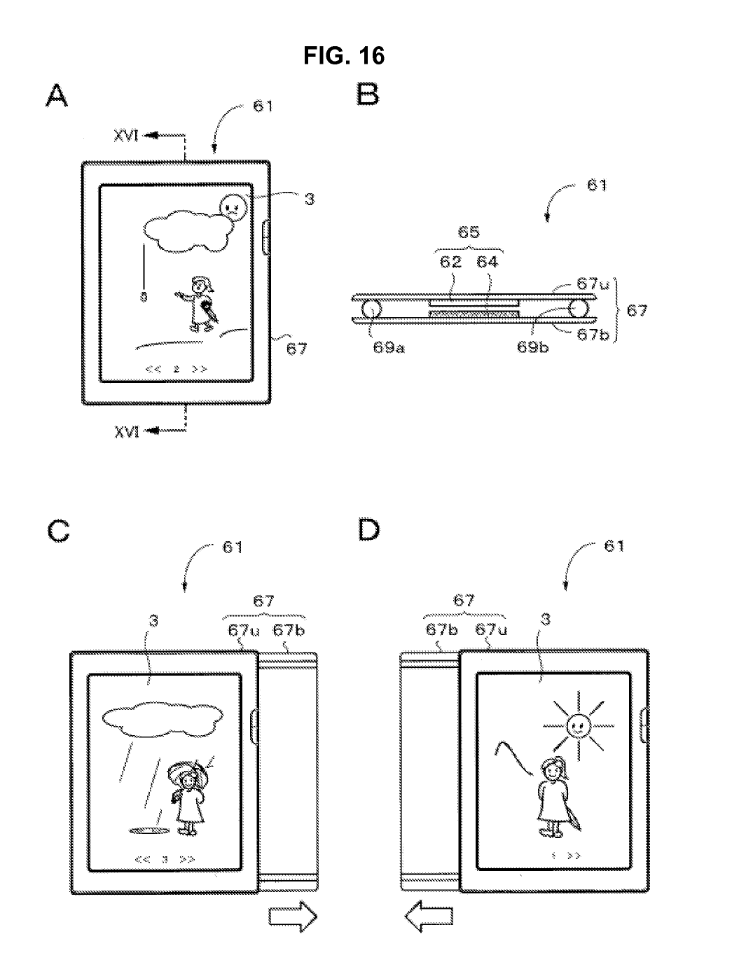

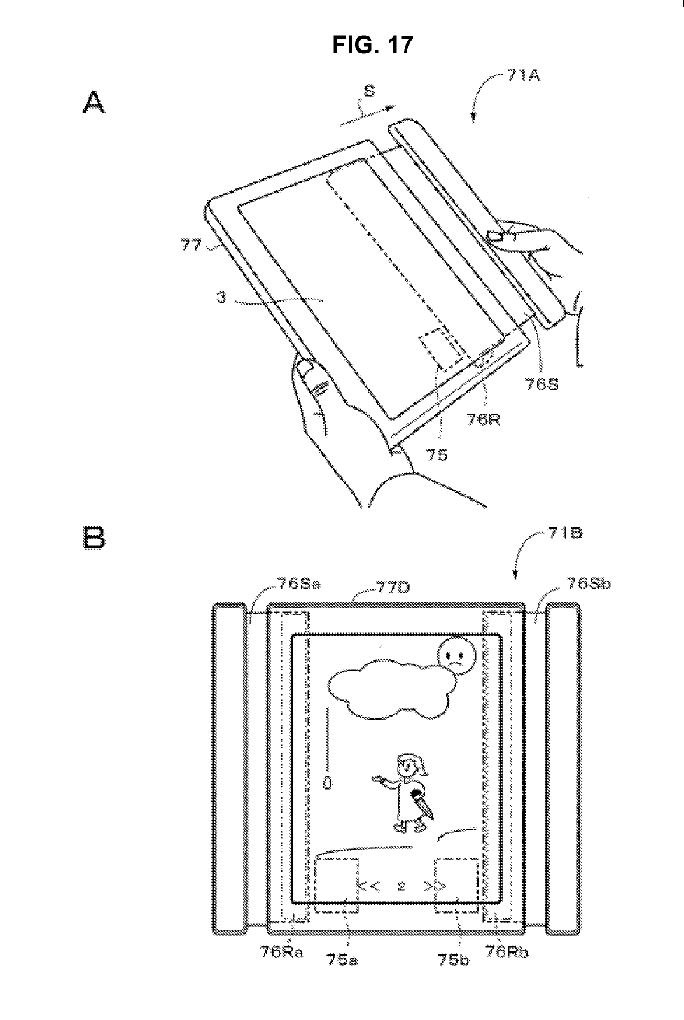

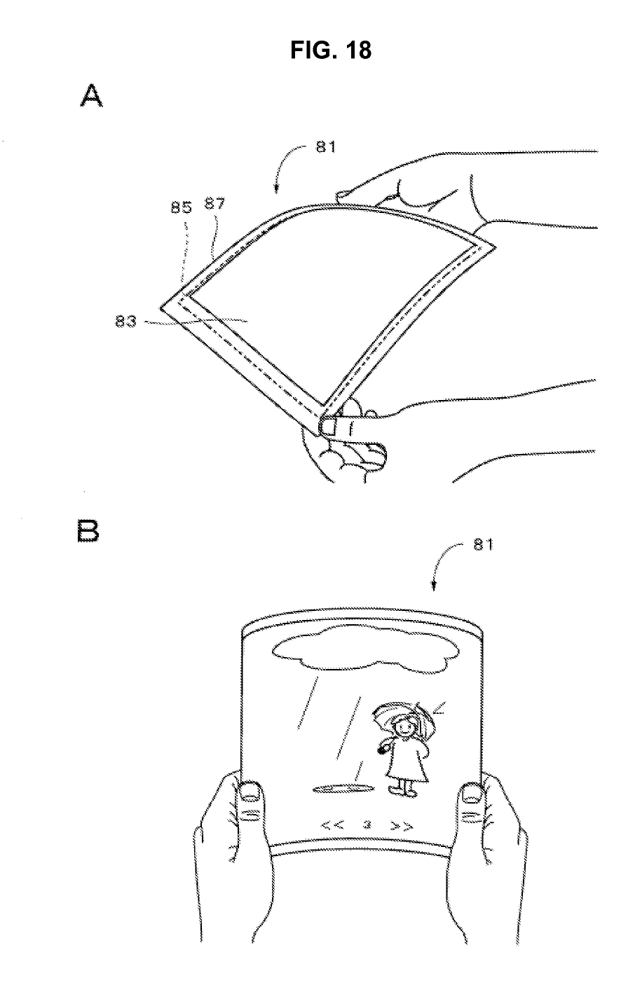

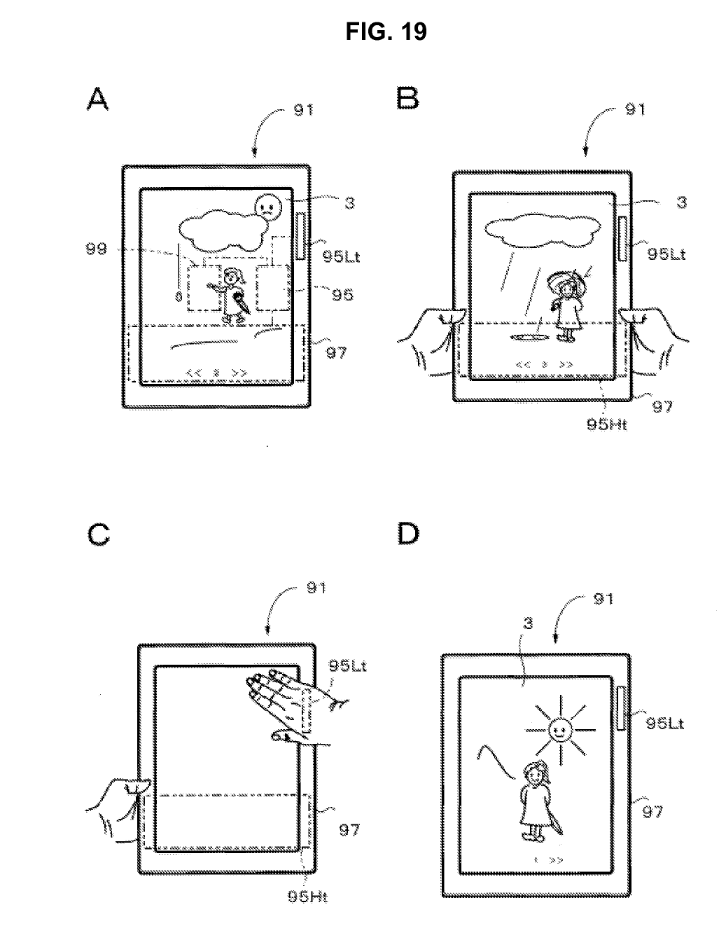

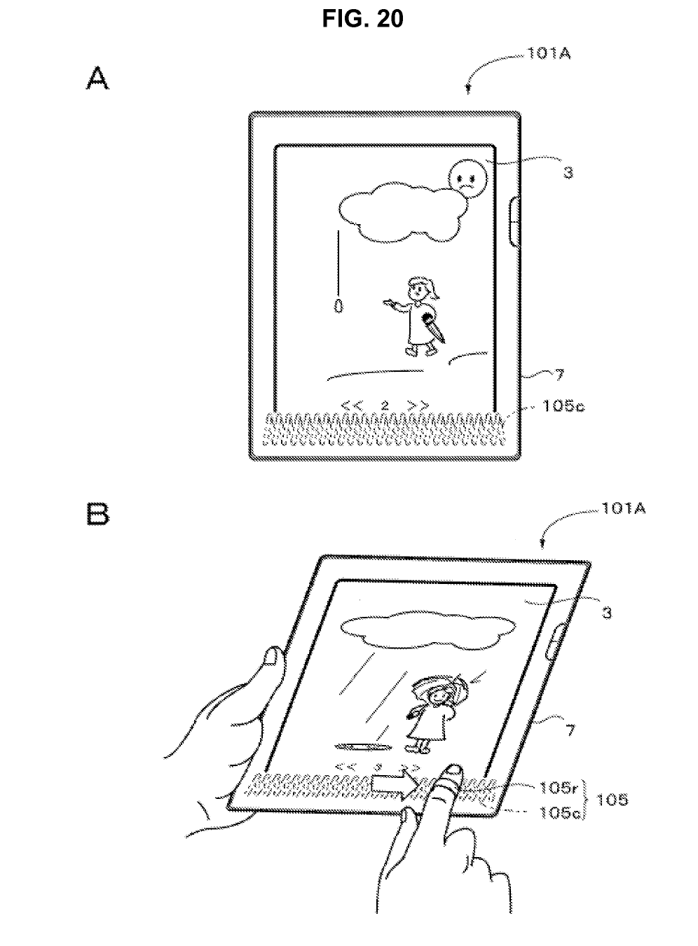

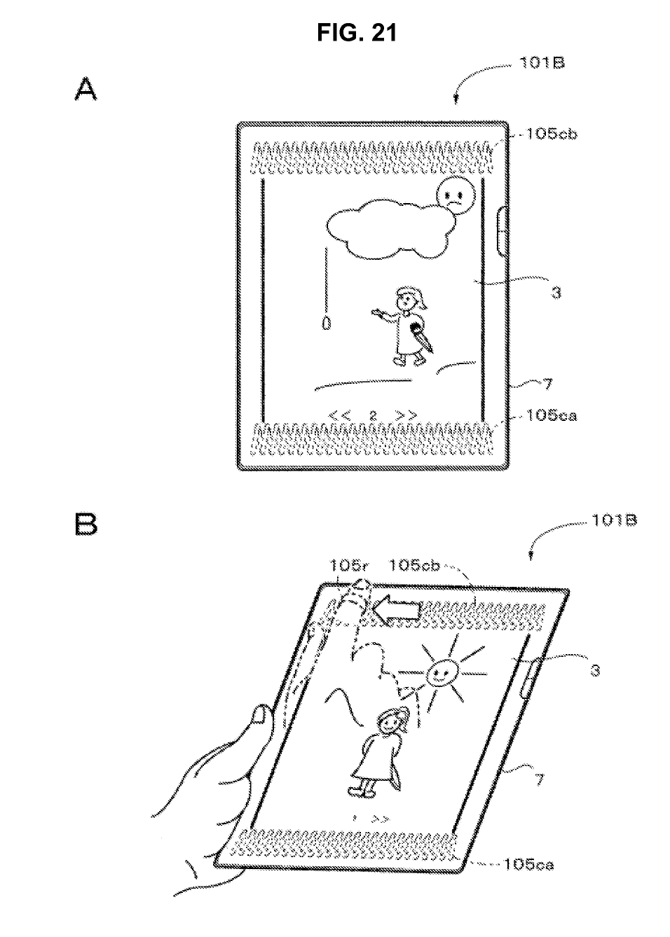

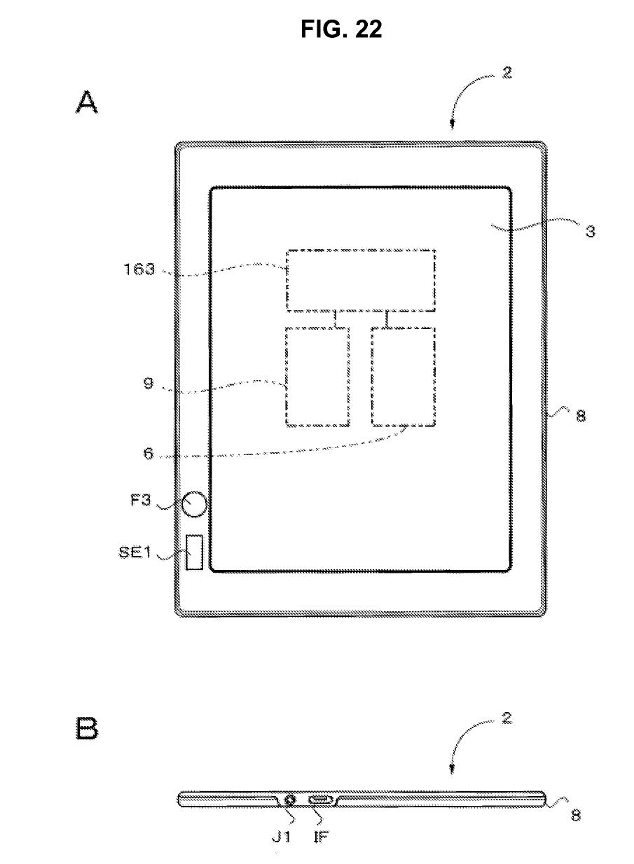

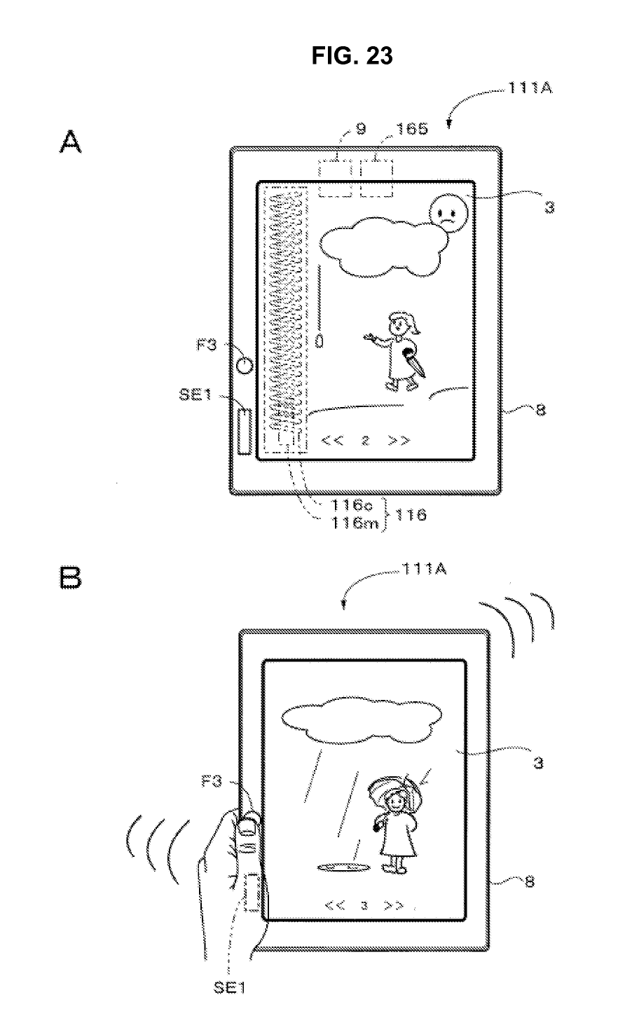

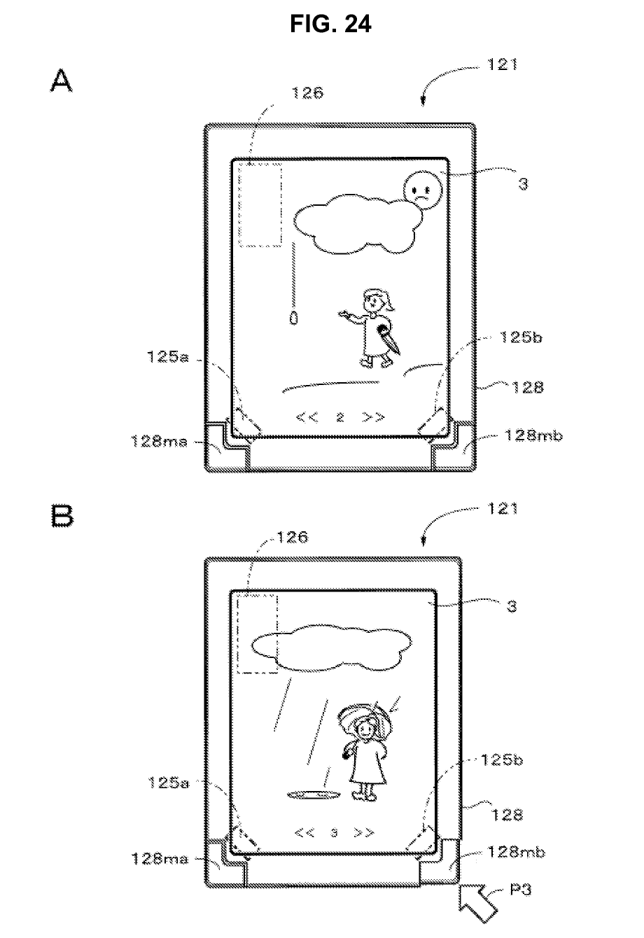

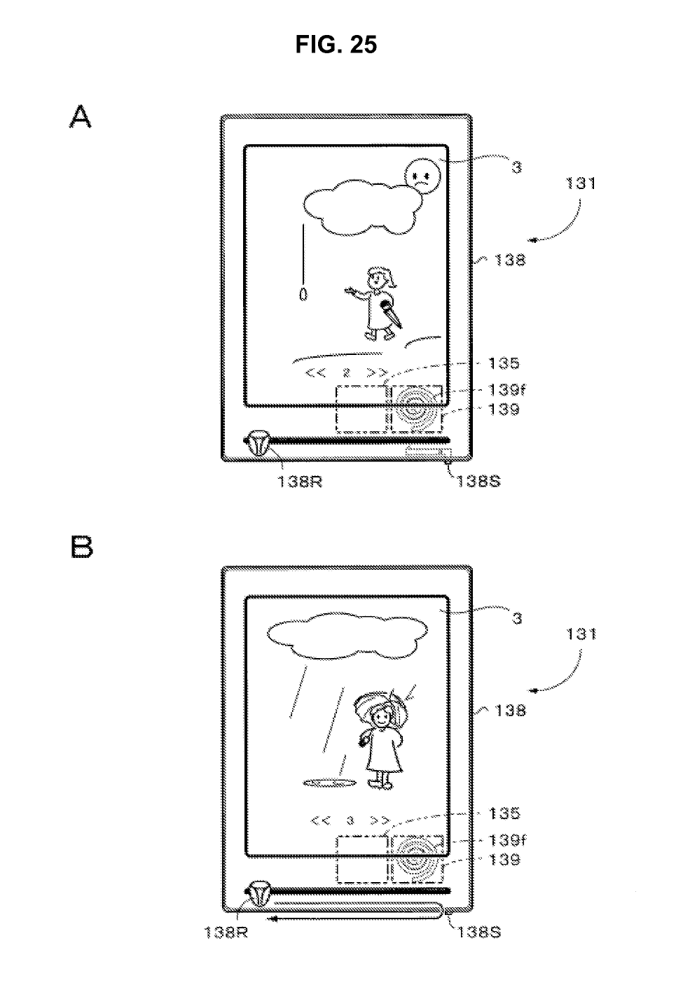

Other objectives, characteristics, and advantageous effects of the technology disposed in the present specification will be clarified by more detailed description based on an embodiment to be described below and accompanying drawings.

[FIG. 1] FIG. 1A is a plan view showing a configuration example of a digital book according to a first embodiment of the present technology. FIG. 1B is a bottom view of the digital book shown in FIG. 1A.

[FIG. 2] FIG. 2 is a block diagram illustrating the configuration example of the digital book shown in FIGS. 1A and 1B.

[FIG. 3] FIG. 3 is a schematic cross-sectional diagram illustrating an example of a configuration of a display unit according to the first embodiment.

[FIG. 4] FIG. 4A is an outline diagram illustrating an example of a power generator that uses an electret. FIG. 4B is an outline diagram illustrating an example of another power generator that uses an electret. FIG. 4C is a plan view showing an opposing face of a rotor to a stator. FIG. 4D is a plan view showing an opposing face of the stator to the rotor.

[FIG. 5] FIG. 5 is a flowchart showing an example of a process performed in the digital book according to an embodiment of the present technology.

[FIG. 6] FIGS. 6A to 6D are diagrams illustrating examples of images displayed on a display unit of the digital book.

[FIG. 7] FIG. 7A is a plan view showing a first configuration example of the digital book. FIG. 7B is a schematic diagram illustrating a cross-section cut along the line VII-VII of the digital book.

[FIG. 8] FIG. 8A is an outline diagram illustrating a use state of the digital book. FIG. 8B is a schematic diagram illustrating a cross-section of the digital book when a user presses the right end side of the digital book. FIG. 8C is an outline diagram illustrating the digital book after page-turning is performed.

[FIG. 9] FIGS. 9A and 9B are schematic diagrams illustrating a cross-section of a digital book in which a generator is further disposed. FIG. 9C is an outline diagram illustrating the digital book after page-turning for turning a page in a backward direction is performed.

[FIG. 10] FIGS. 10A and 10B are schematic diagrams illustrating a cross-section of a digital book configured to have an upper unit constituted by two panels which are joined by a hinge. FIG. 10C is an outline diagram illustrating the digital book of which a display unit displays an initial screen.

[FIG. 11] FIG. 11A is a plan view showing a second configuration example of the digital book. FIG. 11B is a schematic diagram illustrating a cross-section cut along the line XI-XI of the digital book. FIG. 11C is a plan view showing the digital book when a user rotates a lower unit 180°. FIG. 11D is a plan view showing the digital book after page-turning is performed.

[FIG. 12] FIG. 12A is an outline diagram illustrating a configuration example of a digital book in which a rotating member is disposed on the back surface side. FIG. 12B is an outline diagram illustrating a configuration example of the digital book that includes a rotating member which is disposed inside a housing and of which a part is exposed to outside.

[FIG. 13] FIG. 13A is an outline diagram illustrating a third configuration example of the digital book. FIG. 13B is an outline diagram illustrating a configuration example of the digital book in which a track ball is disposed in one part of a housing.

[FIG. 14] FIG. 14A is a plan view showing a fourth configuration example of the digital book. FIG. 14B is a schematic diagram illustrating a cross-section cut along the line XIV-XIV of the digital book. FIG. 14C is a back-side view of the digital book shown in FIG. 14A.

[FIG. 15] FIG. 15A is an outline diagram illustrating a fifth configuration example of the digital book. FIG. 15B is a schematic diagram illustrating a cross-section perpendicular to the center axis of a cylindrical shape of a housing. FIG. 15C is an outline diagram for describing an example of an image displayed on the back surface side of the digital book.

[FIG. 16] FIG. 16A is a plan view showing a sixth configuration example of the digital book. FIG. 16B is a schematic diagram illustrating a cross-section cut along the line XVI-XVI of the digital book. FIG. 16C is a plan view showing the digital book after forward-turning is performed. FIG. 16D is a plan view showing the digital book after backward-turning is performed.

[FIG. 17] FIG. 17A is an outline diagram illustrating a use state of the digital book. FIG. 17B is a plan view showing a configuration example of the digital book that has two respective pairs of rolls and sheets, and generators.

[FIG. 18] FIG. 18A is an outline diagram illustrating an eighth configuration example of the digital book. FIG. 18B is an outline diagram illustrating the digital book after page-turning is performed.

[FIG. 19] FIG. 19A is a plan view showing a ninth configuration example of the digital book. FIG. 19B is a plan view showing the digital book after forward-turning is performed. FIG. 19C is a diagram for describing an input operation of a user for instructing backward-turning in the digital book. FIG. 19D is a plan view showing the digital book after backward-turning is performed.

[FIG. 20] FIG. 20A is a plan view showing a tenth configuration example of the digital book. FIG. 20B is a diagram for describing an input operation of a user for instructing forward-turning in the digital book.

[FIG. 21] FIG. 21A is a plan view showing a configuration example of the digital book that has at least two coils. FIG. 21B is a diagram for describing an input operation of a user for instructing backward-turning in the digital book.

[FIG. 22] FIG. 22A is a plan view showing a configuration example of a digital book according to a second embodiment of the present technology. FIG. 22B is a bottom view of the digital book shown in FIG. 22A.

[FIG. 23] FIG. 23A is a plan view showing an eleventh configuration example of the digital book. FIG. 23B is an outline diagram illustrating the digital book after forward-turning is performed.

[FIG. 24] FIG. 24A is a plan view showing a twelfth configuration example of the digital book. FIG. 24B is a plan view showing the digital book after forward-turning is performed.

[FIG. 25] FIG. 25A is a plan view showing another configuration example of the digital book. FIG. 25B is a plan view showing the digital book after forward-turning is performed.

### DESCRIPTION OF EMBODIMENT

Hereinafter, embodiments of a digital device will be described exemplifying a digital book. Description will be provided in the following order.

<1. First embodiment>

[Outlined configuration example of a digital book]

(Display unit)

(Power generation unit)

(Power storage unit)

(System control unit)

(Housing)

[Overview of an operation of the digital book]

[First configuration example of the digital book]

[Second configuration example of the digital book]

[Third configuration example of the digital book]

[Fourth configuration example of the digital book]

[Fifth configuration example of the digital book]

[Sixth configuration example of the digital book]

[Seventh configuration example of the digital book]

[Eighth configuration example of the digital book]

[Ninth configuration example of the digital book]

[Tenth configuration example of the digital book]

<2. Second embodiment>

[Outlined configuration of a digital book]

(Power generation unit)

[Overview of an operation of the digital book]

[Eleventh configuration example of the digital book]

[Twelfth configuration example of the digital book]

<3. Modified example>

Note that the embodiments described below are appropriate specific examples of the display device. In description below, although various technically preferable limitations are given, an example of the display device will not be limited to the embodiments shown below unless there is particular description to limit the present technology.

### <1. First Embodiment>

### [Outlined Configuration Example of a Digital Book]

FIG. 1A is a plan view showing a configuration example of a digital book according to a first embodiment of the present technology. FIG. 1B is a bottom view of the digital book shown in FIG. 1A. FIG. 2 is a block diagram illustrating the configuration example of the digital book shown in FIGS. 1A and 1B. It should be noted that a drive circuit for driving a display unit 3 is omitted in FIGS. 1A, 1B, and 2, and the same applies to description hereinbelow.

As illustrated in FIGS. 1A and 1B, the digital book 1 according to the first embodiment has the display unit 3, a power generation unit 5, and a housing 7 that houses the display unit 3 and the power generation unit 5. In addition, the digital book 1 according to the embodiment of the present technology has a power storage unit 9 for storing electric power generated by the power generation unit 5.

As illustrated in FIG. 1A, a camera C1, a microphone M1, and the like are disposed in the digital book 1 if necessary. In addition, function buttons F1, F2, and the like which support input operations of a user are disposed in the digital book 1 if necessary. Instead of the function buttons, a touch sensor, or the like may be disposed. As illustrated in FIG. 1B, a jack J1 for bringing electric power from outside, an external interface IF, and the like may also be disposed in, for example, a bottom portion of the digital book 1.

As illustrated in FIGS. 1A and 1B, since the digital book according to the embodiment of the present technology has the housing in a substantial flat plate shape overall, it has a substantial flat plate shape when used by a user. If the digital book has the substantial flat plate shape overall, the user can easily carry the digital book, and can easily operate the digital book in one hand.

As described above, the digital book 1 has the power generation unit 5. The power generation unit 5 has at least one kind of a power generation mechanism. The power generation mechanism transforms, for example, a movement (kinetic energy, or the like) caused by an operation of the digital book by the user into electric energy. Electric power obtained by the power generation unit is supplied to, for example, the display unit, and consumed to rewrite information displayed on the display unit. Here, a movement caused by an operation of the digital book by the user is specifically, for example, so-called page-turning.

Generally, switching images displayed on a display unit in a digital book corresponds to page-turning in a paper medium such as a book, or the like, and there are still many people who prefer to use paper media such as books rather than digital books. One reason that there are many people who prefer to use paper media such as books is assumed to be the difficulty of feeling such page-turning in digital books. Thus, in the present technology, an active movement for giving an instruction of switching images to a digital book is associated with power generation by a power generation mechanism.

Hence, according to the present technology, it is possible to gain electric power necessary for switching images, or the like, which corresponds to page-turning while giving a feeling of page-turning to a user of the digital book. In other words, according to the present technology, since it is not necessary to charge the digital book before it is used outside, the digital book can be made lighter, smaller, and handier. Furthermore, according to the present technology, since the digital book generates electric power with an active movement of a user, special operations for driving the digital book or charging a storage battery thereof are not necessary.

Hereinafter, the display unit 3, the power generation unit 5, the power storage unit 9, a system control unit 163, and the housing 7 will be described in order with reference to FIGS. 1A, 1B, and 2.

### (Display Unit)

The display unit 3 displays content in response to an instruction from a user. At this moment, text information and video information included in the content are displayed on the display unit 3 as still images. Information displayed on the display unit 3 at one time is generally a part of the entire content due to a constraint of the size of the digital book. Thus, the digital book generally displays the entire content by switching a plurality of images based on instructions of the user.

A display method of the display unit 3 is not particularly limited among the methods of, for example, electrophoretic display, magnetophoretic display, twisting ball display, electron powder fluid display, liquid crystal display, thermosensitive display, electrolytic deposition display, electrowetting display, photochromic display, electrochromic display, and the like, however, in terms of reducing power consumption of the digital book, a method that consumes low power in rewriting information displayed on the display unit 3 is preferable. In terms of not necessitating a storage battery, a method that requires little to no electric power for retaining a displayed image, for example, a toner display method or a method using a cholesteric liquid crystal, is preferable as a display method of the display unit 3.

Note that the display unit 3 may perform color display or monochromic display. The display unit 3 may be configured as a touch panel on which input operations are possible.

As an example of an information display method of the display unit 3, an information display method using a so-called microcapsule-based electrophoretic display method will be described below with reference to FIG. 3. The microcapsule-based electrophoretic display method is preferable as an information display method of the display unit 3 because the method requires no electric power for retaining an image once displayed.

FIG. 3 is a schematic cross-sectional diagram illustrating an example of a configuration of the display unit according to the first embodiment. The display 183 shown in FIG. 3 has an upper unit 187u, a lower unit 187b that is disposed facing the upper unit 187u, and a microcapsule layer (a medium layer) 189. The upper unit 187u is constituted by a transparent base material 186u and a transparent conductive layer 188u, and the transparent conductive layer 188u is formed on a main face of the transparent base material 186u facing the lower unit 187b. In the same manner, the lower unit 187b is constituted by a transparent base material 186b and a transparent conductive layer 188b, and the transparent conductive layer 188b is formed on a main face of the transparent base material 186b facing the upper unit 187u. The microcapsule layer 189 is disposed between the transparent conductive layer 188u and the transparent conductive layer 188b. The microcapsule layer 189 includes a number of microcapsules 180, and each of the microcapsules 180 contains, for example, a transparent liquid (a dispersion medium) in which black particles and white particles are dispersed.

The black particles and the white particles in the microcapsules 180 are, for example, positively and negatively charged, respectively. For this reason, by generating an electric field between the transparent conductive layer 188u and the transparent conductive layer 188b by supplying a current to the transparent conductive layer 188u and the transparent conductive layer 188b, the black particles can be selectively collected on a side close to, for example, the transparent conductive layer 188u. If the display 183 is observed from the side of the upper unit 187u at this moment, the microcapsules 180 appear black. If an electric field between the transparent conductive layer 188u and the transparent conductive layer 188b is reversed, the white particles are collected on a side close to the transparent conductive layer 188u. For this reason, when the display 183 is observed from the side of the upper unit 187u, the microcapsules 180 appear white. Thus, the display can be selectively expressed in black or white according to a direction of the electric field between the transparent conductive layer 188u and the transparent conductive layer 188b.

### (Power Generation Unit)

The power generation unit 5 includes one or more power generation mechanisms. Each power generation mechanism is constituted by, for example, a power generation element, a power generator, or a combination of the aforementioned elements and a mechanical mechanism, and the power generation mechanism transforms kinetic energy or heat energy caused by a movement made by a user for instructing switching of images into electric energy. The power generation unit 5 may be configured as a power generation system that first accumulates energy obtained from a movement made by a user for instructing switching of images as elastic energy or heat energy and then transforms the accumulated energy into electric energy if necessary.

As the movement made by a user for instructing switching of images, various movements, for example, turning, sliding, waggling (shaking), pressing, tapping, bending (twisting), warming, and the like are exemplified. The movement made by a user for instructing switching of images is preferably a simple movement.

A volume that the power generation mechanism accounts for in the digital book 1 is preferably not excessively large with respect to the entire digital book 1. In other words, when the power generation mechanism has a movable portion, for example, an operation of the movable portion is preferably completed within a plane.

The power generation mechanism includes a power generation element that generates voltages from, for example, mechanical motions or temperature differences. As the power generation element, for example, a piezoelectric element (a monomorph type, a bimorph type, a laminated type, or the like), a magnetostrictor, a thermoelectric conversion element (an element using a Seebeck effect or a spin Seebeck effect, or the like), a pyroelectric element, a photovoltaic element, and the like are exemplified, and the power generation element may be a hybrid-type power generation element obtained by combining one or more kinds of the elements mentioned above. The power generation mechanism may be configured as a power generation module obtained by combining a power generation element and a mechanical mechanism.

Alternatively, the power generation mechanism may be configured as, for example, a power generator that generates a voltage from relative motions between members. As the power generator that generates a voltage from relative motions between members, for example, a power generator that uses an electromagnetic induction phenomenon or electret is exemplified.

FIG. 4A is an outline diagram illustrating an example of a power generator that uses an electret. As illustrated in FIG. 4A, a conductor substrate 192 that is formed of a metal, or the like and an electret 194 are disposed in the power generator 193 facing each other. The electret is a dielectric material in which electric charges are injected, and can generate a permanent electrostatic field. Since the electret 194 forms an electrostatic field, in a portion of the conductor substrate 192 facing the electret 194, induced charges are generated due to the electrostatic field formed by the electret 194. Thus, if the area of a portion in which the conductor substrate 192 overlaps the electret 194 is changed by causing the conductor substrate 192 and the electret 194 to make rectilinear movements, the amount of charges induced in the conductor substrate 192 changes. In other words, a current leaks to the outside of the power generator 193, and a current flows in a load 190. The conductor substrate 192 and the electret 194 may be caused to make rectilinear movements in a direction in which the distance between the conductor substrate 192 and the electret 194 changes.

Note that, when a voltage is generated from a mechanical movement, it is preferable to generate power by transforming a rectilinear movement into a rotational movement. This is because a temporal change of a generated voltage can be mitigated in comparison to a case in which, for example, an impact exerted on the power generation element or a member is used.

FIG. 4B is an outline diagram illustrating an example of another power generator that uses an electret. In the power generator 195, a rotor 197 and a stator 199, which have disk shapes, are disposed facing each other substantially in parallel as illustrated in FIG. 4B. For example, the rotor 197 is assumed to be a disk having a conductor substrate such as a metal and the stator 199 is assumed to be a disk having an electret. In contrast, the rotor 197 may be a disk having an electret and the stator 199 may be a disk having a conductor substrate such as a metal.

FIG. 4C is a plan view showing an opposing face of the rotor to the stator. FIG. 4D is a plan view showing an opposing face of the stator to the rotor. As shown in FIGS. 4B to 4D, both the rotor 197 and the stator 199 are patterned. As shown in FIG. 4C, for example, conductive parts c1, c2, c3, and c4 which are formed of conductor substrates are formed on one main face of a base material 196r which is formed of a resin material, or the like, thereby constituting the rotor 197. In addition, as shown in FIG. 4D, for example, electrets e1, e2, e3, and e4 are formed on one main face of a base material 196s which is formed of a resin material, or the like, thereby constituting the stator 199.

Thus, as the rotor 197 rotates with respect to the stator 199, an area of portions in which the conductor substrates overlap the electrets changes, then an amount of charges induced to the conductor substrates changes, and accordingly, a current leaks to the outside. In order to reduce loss caused by friction, or the like, a pneumatic bearing is preferably applied as a bearing supporting the rotor 197.

As a mechanism for changing rectilinear movements to rotational movements, for example, a crank mechanism, a gear mechanism, or the like is exemplified, however, the mechanism is not limited thereto. The power generation mechanism may have a spiral spring, a flywheel, or the like. Note that the digital book may further have a power generation element or a power generator that generates power with no direct relation to a movement made by a user for instructing switching of images. To be specific, for example, the digital book may have a power generation element such as a solar cell, an enzyme battery, a fuel cell, an atomic battery, or a thermoelectric transducer, or a power generation element using rectification of electromagnetic waves. As the power generation element using electromagnetic waves, for example, a rectenna (rectifying antenna), or the like is exemplified.

Alternatively, for example, the digital book may further have a power generation mechanism that generates voltages from shaking accompanied by carrying of the digital book by a user. Electric power gained from a power generation element or a power generator that generates power with no direct relation to a movement made by a user for instructing switching of images is, for example, temporarily stored in the power storage unit to be described later, and consumed for driving the digital book if necessary.

### (Power Storage Unit)

The power storage unit 9, for example, temporarily stores electric power obtained from the power generation mechanism, and supplies the electric power to each unit of the digital book 1 if necessary.

The power storage unit 9 includes a power storage device, for example, a secondary battery, a capacitor, or the like. As the secondary batter, for example, a lithium-ion battery, a sodium-sulfur battery, a zinc battery, a nickel-hydrogen battery, a nickel-zinc battery, a nickel-iron battery, a silver-zinc battery, a nickel-cadmium battery, a redox flow battery, or the like is exemplified. Of course, the secondary battery is not limited thereto, and may be a combination of one or more kinds thereof. As the capacitor, for example, an electrical double layer capacitor, a Nanogate capacitor (“Nanogate” is a registered trademark of Nanogate Aktiengesellschaft), a lithium-ion capacitor, a polyacenic semiconductor (PAS) capacitor, or the like is exemplified. Of course, the capacitor is not limited thereto.

The power storage unit 9 is preferably a composite power storage system constituted by a set of two or more power storage devices such as the secondary batter, the capacitor, and the like. This is because individual power storage devices can be selectively used in accordance with, for example, a difference in charge and discharge characteristics of the individual power storage devices. Of course, the power storage system may include a main battery.

### (System Control Unit)

The system control unit 163 is constituted by, for example, a power source management unit 173, a control signal detection unit 175, a central processing unit 177, a display control unit 179, and the like, and controls each unit of the digital book 1.

The power source management unit 173 includes, for example, a rectifying circuit, a smoothing circuit, a booster circuit, a charge-discharge control circuit, and the like, and emits electric power necessary for each unit of the digital book 1 according to a control signal from the central processing unit 177 to be described later.

In addition, the power source management unit 173 is electrically connected to the power generation unit 5. When a current emitted from the power generation unit 5 is an alternating current, for example, the alternating current is converted into a direct current via the rectifying circuit and the smoothing circuit. Electric power obtained by the power generation unit 5 is first supplied to the power source management unit 173, and then emitted from the power source management unit 173 to each unit of the digital book 1. In addition, when the digital book 1 has the power storage unit 9, for example, the power source management unit 173 causes surplus electric power of the electric power obtained by the power generation unit 5 to be charged in the power storage device of the power storage unit 9. When the electric power obtained by the power generation unit 5 is not sufficient as electric power necessary for re-writing information displayed on the display unit 3, for example, the power source management unit 173 applies the electric power stored in the power storage unit 9 to electric power for driving the display unit 3.

The power source management unit 173 feeds power to a memory unit 167 built in the digital book 1 or the external interface IF. When an external memory device 168 is connected to the external interface IF, electric power is supplied to the external memory device 168 via the external interface IF.

To be specific, the memory unit 167 is a memory medium, for example, a memory, a hard disk, or the like, and stores data of content to be displayed on the display unit 3. Adding or updating of data is performed via the external interface IF using, for example, a wired or a wireless method. When the external interface IF has communication means, for example, new data of content can be acquired from a network NW such as the Internet. In addition, when the external memory device 168 is an external memory device such as a flash memory storing data of content, for example, the external memory device 168 is inserted into a slot provided in, for example, the housing 7. The external memory device 168 is connected to the external interface IF disposed in the slot, and then data of content stored in the external memory device 168 is acquired.

The control signal detection unit 175 determines details of instructions from a user to the digital book based on input signals from, for example, the power generation unit 5 or a sensor 165. For example, as the control signal detection unit 175 detects a change in a voltage generated by the power generation unit 5, electric power generated by the power generation unit 5 may be used as electric signals. By using electric power generated by the power generation unit 5 as electric signals, an electric power line can be used as a signal line, and a signal line can be dropped.

In addition, the sensor 165 senses, for example, a current moving direction or a current inclination of the housing 7, and notifies the control signal detection unit 175 of the result. Alternatively, the sensor 165 senses, for example, whether or not a user currently touches a specific part of the digital book and notifies the control signal detection unit 175 of the result. The control signal detection unit 175 can determine whether or not, for example, the digital book 1 is currently used by the user using an input signal from the sensor 165.

The display control unit 179 reads data of content stored in the memory unit 167, then generates a drive signal of the display unit 3, and then causes the display unit 3 to display information that the user desires.

The central processing unit 177 is a processing unit that includes a processor, and is configured as, for example, a digital signal processor (DSP), or a central processing unit (CPU). The central processing unit 177 controls the above-described power source management unit 173, the control signal detection unit 175, and the display control unit 179, and monitors a drop in a remaining battery level of the storage battery of the power storage unit 9, or the like.

### (Housing)

The housing 7 accommodates the display unit 3, the power generation unit 5, the power storage unit 9, the system control unit 163 and the like described above. In terms of easy operations of the digital book by the user in one hand and securing a display area of the display unit, a shape of the housing 7 is preferably a substantial flat plate shape overall, but is not limited thereto. For example, a narrow part, or the like may be formed in a part of the housing 7. A material forming the housing 7 can be appropriately selected from, for example, resin materials, metal materials, and the like.

### [Overview of an Operation of the Digital Book]

Next, an overview of an operation of the digital book according to an embodiment of the present technology will be described with reference to FIG. 5.

FIG. 5 is a flowchart showing an example of a process performed in the digital book according to the embodiment of the present technology. FIG. 5 shows an example of a process flow by the system control unit 163.

First, in Step S1, the system control unit 163 determines whether or not electromotive force has been generated in the power generation unit 5. When electromotive force is generated in the power generation unit 5, the process proceeds to Step S2. On the other hand, when electromotive force is not generated in the power generation unit 5, it means that the user does not want to perform page-turning, and thus the process proceeds to Step S10.

Next, in Step S2, electric power obtained from the power generation unit 5 is stored if necessary. Power storage in this case is temporary power storage, for example, charging of the capacitor.

Next, in Step S3, the system control unit 163 determines whether or not the generation of the electromotive force in the power generation unit 5 is caused by a movement made by the user for instructing switching of images. When the generation of the electromotive force in the power generation unit 5 is not caused by a movement made by the user for instructing switching of images, it means that the user does not intend to operate the digital book 1, and thus the process proceeds to Step S4. In Step S4, electric power obtained from the power generation unit 5 is supplied to the power storage unit 9, and the power storage device of the power storage unit 9 is charged. When the generation of the electromotive force in the power generation unit 5 is determined to be caused by a movement made by the user for instructing switching of images, the process proceeds to Step S5.

Next, in Step S5, the system control unit 163 determines whether or not an input from the power generation unit 5 is an input for turning the power of the digital book 1 off. When the input from the power generation unit 5 is an input for turning the power of the digital book 1 off, the process proceeds to Step S6, and power supply to the digital book 1 is disconnected. On the other hand, when the input from the power generation unit 5 is not an input for turning the power of the digital book 1 off, the process proceeds to Step S7.

Next, in Step S7, the system control unit 163 determines whether or not an input from the power generation unit 5 is an input for turning the power of the digital book 1 on. When the input from the power generation unit 5 is an input for turning the power of the digital book 1 on, the process proceeds to Step S8, and the digital book 1 is in an activated state. For example, in Step S8, the system control unit 163 causes the display unit 3 to display an initial screen such as a menu screen. On the other hand, when the input from the power generation unit 5 is not an input for turning the power of the digital book 1 on, the process proceeds to Step S9.

In Step S9, the system control unit 163 rewrites information displayed on the display unit 3. In other words, page-turning is executed. Note that, when the digital book 1 is not in the activated state, if there is an input that is neither an input for turning the power off nor an input for turning the power on, for example, an input for page-turning, the user is considered to want to use the digital book 1. Thus, in such a case, for example, information displayed during the previous use or the initial screen may set to be displayed.

When page-turning is executed in Step S9, the process returns to Step S1. Note that when a time T₀ set in advance elapses while the digital book 1 is in the activated state and the user does not perform an input operation, the process proceeds from Step S10 to Step S6 to turn the power of the digital book 1 off.

FIGS. 6A to 6D are diagrams illustrating examples of images displayed on the display unit of the digital book. When the digital book 1 is in the activated state, for example, the initial screen is displayed on the display unit 3 of the digital book 1 as illustrated in FIG. 6A. The initial screen illustrated in FIG. 6A shows that content such as “novel,” “dictionary,” and “cartoon” is stored in the digital book 1. In addition, in the lower part of the display unit 3, a part of the content currently selected is previewed.

It is assumed that the user performs an input operation for selecting, for example, the “dictionary” from the content stored in the digital book 1. At this moment, the power generation mechanism of the power generation unit 5 generates electric power due to the input operation for selecting the “dictionary,” the electric power obtained by the power generation unit 5 is supplied to the display unit 3. Thus, the information displayed on the display unit 3 is re-written, and content of the “dictionary” is displayed on the display unit 3 as illustrated in FIG. 6B.

In the example illustrated in FIG. 6B, tabs of “A,” “B,” “C,” . . . are displayed, and when the user performs an input operation for selecting the tab of “A,” for example, power generation by the power generation mechanism of the power generation unit 5 and re-writing of the information displayed on the display unit 3 are performed. Then, content included in the group of “A” out of the content of the “dictionary” is displayed on the display unit 3 as illustrated in FIG. 6C.

For example, when the user performs an input operation for selecting, for example, the “novel” from the content stored in the digital book 1, content of the “novel” is displayed on the display unit 3 as illustrated in FIG. 6D. At this moment, each chapter is displayed in an index as a tab, and when electric power is generated by the power generation mechanism of the power generation unit 5 according to an operation input for selecting a tab by the user, re-writing of information displayed on the display unit 3 is performed. In other words, a display of the current tab of the chapter selected by the user is switched.

### [First Configuration Example of the Digital Book]

FIG. 7A is a plan view showing a first configuration example of the digital book. FIG. 7B is a schematic diagram illustrating a cross-section cut along the line VII-VII of the digital book.

The digital book 11A includes an upper unit 17u in which the display unit 3 is disposed, and a lower unit 17b facing the upper unit 17u with an interval of about 1 mm to 10 mm as illustrated in, for example, FIGS. 7A and 7B. In other words, the pair of the upper unit 17u and the lower unit 17b constitutes a housing 17 of the digital book 11A.

The left end side of the lower unit 17b and the right end side of the upper unit 17u are connected by a supporting member 16 that is formed of, for example, a resin material or a metal material. Likewise, the left end side of the upper unit 17u and the right end side of the lower unit 17b are connected by a supporting member 18 that is formed of, for example, a resin material or a metal material. The supporting member 16 and the supporting member 18 are formed to be, for example a flat plate shape, and the supporting member 16 and the supporting member 18 are held so as to freely pivot about the intersectional line formed by the main face of the supporting member 16 and the main face of the supporting member 18. The supporting member 16 and the supporting member 18 are set to have elasticity, and specifically, function as a plate spring.

In addition, as illustrated in FIG. 7B, a power generation element 15a is disposed between the upper unit 17u and the lower unit 17b on the left end side of the digital book 11A, and a power generation element 15b is disposed between the upper unit 17u and the lower unit 17b on the right end side of the digital book 11A. The power generation element 15a and the power generation element 15b are power generation elements, for example piezoelectric elements that generate voltages as force is exerted thereon. Note that a power storage unit, a system control unit, and the like are not shown in FIGS. 7A and 7B, and the same applies to description below unless specified otherwise.

FIG. 8A is an outline diagram illustrating a use state of the digital book. FIG. 8B is a schematic diagram illustrating a cross-section of the digital book when a user presses the right end side of the digital book. FIG. 8C is an outline diagram illustrating the digital book after page-turning is performed. As illustrated in FIG. 8A, when the user grabs at least one of the left end side and the right end side of the digital book 11A during use of the digital book 11A, the digital book 11A is held. Here, the upper unit 17u and the lower unit 17b are assumed to be sufficiently rigid as not to warp. Then, since the upper unit 17u and the lower unit 17b of the digital book 11A are connected by the supporting member 16 and the supporting member 18 that have elasticity, the user can press the left end side and the right end side of the digital book 11A so as to bring the upper unit 17u and the lower unit 17b close to each other.

As illustrated in FIG. 8B, when the user presses the right end side of the digital book 11A by exerting, for example, pressure P1 on the right end of the digital book 11A, force is exerted on the power generation element 15b according to the pressing operation by the user. The power generation element 15b generates a voltage according to the exerted force. Thus, the digital book performs power generation from the pressing operation by the user, thereby obtaining electric power.

Electric power obtained from the pressing operation by the user is supplied to, for example, the power source management unit 173. The power source management unit 173 supplies some of the electric power supplied from the power generation element 15b to the control signal detection unit 175. The control signal detection unit 175 notifies the central processing unit 177 of the fact that there was supply of power from the power generation element 15b by receiving an input of a signal from the power source management unit 173 or an input of the electric power supplied from the power source management unit 173. The central processing unit 177 emits a control signal to the display control unit 179. The display control unit 179 that received the control signal from the central processing unit 177 reads information from the memory unit 167. The power source management unit 173 supplies to the display unit 3 electric power for switching an image currently displayed on the display unit 3. The display control unit 179 rewrites the image currently displayed on the display unit 3 into a new image. Thus, page-turning in the digital book 11A is executed according to the pressing operation performed by the user.

FIGS. 9A and 9B are schematic diagrams illustrating a cross-section of a digital book in which a generator is further disposed. FIG. 9C is an outline diagram illustrating the digital book after page-turning for turning a page in a backward direction is performed. As illustrated in FIGS. 9A and 9B, a generator 15c may be further disposed around the center between the left end and the right end of the digital book 11B. The generator 15c is assumed to have, for example, a rotor and a stator. In addition, the rotation axis of the rotor is assumed to coincide with a rotation axis of, for example, the supporting member 16 or the supporting member 18, and the rotor rotates according to pivoting of the supporting member 16 or the supporting member 18. Thus, the rotor rotates according to a pressing operation performed by a user, thereby obtaining electric power from the generator 15c.

Note that, when electric power obtained from power generation by the power generation elements exceeds electric power necessary for re-writing information displayed on the display unit 3, surplus electric power is stored in, for example, the power storage unit. On the other hand, when electric power obtained from power generation by the power generation elements is insufficient as electric power necessary for re-writing information displayed on the display unit 3, electric power stored in the power storage unit may fill the deficiency.

However, as page-turning, page-turning for turning a page in a forward direction (hereinafter referred to as forward-turning) and page turning for turning a page in a backward direction (hereinafter referred to as backward-turning) are considered. An input operation for forward-turning and an input operation for backward-turning can correspond respectively to, for example, pressing the right end side and pressing the left end side of the digital book.

As illustrated in FIG. 9B, when the user presses the digital book 11B by exerting pressure P2 on, for example, the left end of the digital book 11B, force is exerted on the power generation element 15a according to the pressing operation by the user. The power generation element 15a generates a voltage according to the exerted force. On the other hand, force is exerted on the power generation element 15b in the direction opposite to the force exerted on the power generation element 15a. In other words, it can be determined whether a pressing operation is performed on the right end side and the left end side of the digital book based on, for example, the polarity of a voltage generated in the power generation element 15a, the power generation element 15b, or the generator 15c. In other words, whether page-turning that the user intends is forward-turning or backward-turning can be determined based on the polarity of a voltage generated in the power generation element 15a, the power generation element 15b, or the generator 15c.

FIGS. 10A and 10B are schematic diagrams illustrating a cross-section of a digital book configured to include an upper unit constituted by two panels which are joined by a hinge. FIG. 10C is an outline diagram illustrating the digital book of which a display unit displays an initial screen. As illustrated in FIGS. 10A and 10B, the upper unit of the digital book may be constituted by, for example, a plurality of panels joined by a hinge. The configuration example illustrated in FIGS. 10A and 10B is an example of a digital book configured to have an upper unit constituted by a panel 17L and a panel 17R which are arranged side-by-side and joined by a hinge H. In this case, the digital book 11C has two displays arranged side-by-side, and the upper unit can bend around the hinge H serving as a pivot.

Instead of the upper unit, a lower unit may be constituted by, for example, a plurality of panels joined by a hinge, or the like. In this case, a display surface of the display unit provided in the upper unit can be a flat display surface with no discontinuity caused by the hinge, or the like.

Alternatively, a display unit that has flexibility may be configured to be disposed in the upper unit and thereby the upper unit serves as a unit with flexibility as a whole. In this case, the lower unit may have flexibility, but may preferably have sufficient rigidity that the lower unit does not warp. This is because, when a piezoelectric element is used as a power generation element, pressing force is preferably transmitted to the piezoelectric element with reliability.

In the configuration examples illustrated in FIGS. 7A, 7B, 8A to 8C, 9A to 9C, 10A and 10B, a plurality of kinds of inputs can be associated with operations of the user. For example, pressing the right end side of the digital book can be designated as a first input, pressing the left end side of the digital book as a second input, and pressing the right and left end sides of the digital book as a third input. For example, an input for forward-turning, an input for backward-turning, and an input for activating the digital book can be designated as the first input, the second input, and the third input, respectively

When, for example, the user exerts pressure P1 and P2 on the left end and the right end of the digital book 11C, respectively, so as to press the left end side and the right end side of the digital book 11C as illustrated in FIG. 10B, the initial screen is displayed on the display unit of the digital book 11C as illustrated in FIG. 10C.

In FIG. 7B, the configuration example in which the two power generation elements are disposed on the left end side and the right end side of the digital book has been shown, but a number of power generation elements may be further disposed between the upper unit and the lower unit. When four power generation elements are disposed in, for example, the upper left corner, the upper right corner, the lower left corner, and the lower right corner of the digital book, a number of inputs can be further designated. The number of pages to turn can also be set in units of, for example, one page by pressing the lower right corner of the digital book, or ten pages by pressing the upper right corner of the digital book. According to the way of combining portions for which pressing operations are performed, individual inputs may be designated.

Further, by setting threshold values for an input voltage from the power generation elements or generator in multiple stages, a plurality of inputs can also be designated according to the size of the voltage generated by the power generation elements or generator.

Note that, in order to prevent page-turning that the user does not want from being executed, page-turning may be executed when a pressing operation by the user corresponds to so-called double-clicking. Alternatively, page-turning may be executed only when a pressing operation by the user continues over a time period set in advance. In addition, page-turning may be executed only when a function button, or the like provided in a portion separate from a portion in which a pressing operation is performed is pressed and then a pressing operation by the user is performed.

In addition, in FIG. 7B for example, the configuration example in which the supporting member 16 and the supporting member 18 are held so as to freely pivot about one rotation axis has been shown, however, two or more supporting members are set to have shapes that do not interfere with each other, and the two or more members may be disposed to intersect each other. The supporting members are set to have, for example, elasticity, however, instead of or together with the supporting members, coil springs may be disposed between the upper unit and the lower unit.

In FIG. 7B, for example, the configuration example in which the digital book 11A has the power generation element 15a and the power generation element 15b has been shown, however, one of the power generation element 15a and the power generation element 15b may be omitted. Note that a method of power generation may be any of an electrostatic type, an electromagnetic type, a reverse magnetostrictive type, a piezoelectric type, and the like.

As described above, the digital book obtains electric power by performing power generation from pressing operations by a user. In other words, in the present technology, power generation for obtaining electric power necessary for re-writing information displayed on a display device is performed with input operations for page-turning performed by a user. According to the present technology, since the digital book obtains electric power from built-in power generation elements or a generator and thereby re-writes information displayed on the display unit, page-turning in the digital book can be realized without necessitating charging of the digital book before use.

### [Second Configuration Example of the Digital Book]

FIG. 11A is a plan view showing a second configuration example of the digital book. FIG. 11B is a schematic diagram illustrating a cross-section cut along the line XI-XI of the digital book. FIG. 11C is a plan view showing the digital book when a user rotates a lower unit 180°. FIG. 11D is a plan view showing the digital book after page-turning is performed.

The digital book 21A is configured to include, for example, an upper unit 27u on which the display unit 3 is disposed, and a lower unit 27b that is disposed to overlap the upper unit 27u as illustrated in FIGS. 11A and 11B. In other words, a pair of the upper unit 27u and the lower unit 27b constitutes a housing 27 of the digital book 21A. The lower unit 27b freely rotates with respect to, for example, the upper unit 27u, and the rotation axis thereof is positioned at, for example, the center of the upper unit 27u so as to coincide with an axis perpendicular to the main face of the upper unit 27u. A generator 25 is disposed, for example, between the upper unit 27u and the lower unit 27b. The generator 25 is constituted by, for example, a pair of a stator 25s and a rotor 25r. For example, the stator 25s is disposed over the upper unit 27u of the digital book 21A and the rotor 25r is disposed over the lower unit 27b of the digital book 21A sharing the rotation axis of the lower unit 27b with respect to the upper unit 27u.

Since the lower unit 27b of the digital book 21A is set to freely rotate with respect to the upper unit 27u, the user can rotate the lower unit 27b of the digital book 21A, for example, 180° with respect to the upper unit 27u.

As illustrated in FIG. 11C, when the lower unit 27b of the digital book 21A is rotated 180° with respect to the upper unit 27u, the generator 25 performs power generation according to the rotation operation of the lower unit 27b by the user since the generator 25 is disposed between the upper unit 27u and the lower unit 27b. Thus, the digital book 21A performs power generation from a rotation operation of the lower unit 27b by the user, thereby obtaining electric power necessary for re-writing of information displayed on the display unit 3.

In the configuration example illustrated in FIGS. 11A and 11B, the lower unit 27b is rotated with respect to the upper unit 27u within a plane parallel to the main face of the display unit 3 of the digital book 21A. For this reason, a space necessary for the rotation operation of the lower unit 27b can be reduced more than when the lower unit is rotated within a plane perpendicular to the main face of the display unit 3.

An input operation for forward-turning and an input operation for backward-turning can correspond respectively to, for example, clockwise rotation and counterclockwise rotation of the lower unit with respect to the upper unit of the digital book. In other words, whether page-turning that the user intends is forward-turning or backward-turning can be determined based on the polarity of a voltage generated in the generator. Alternatively, a power generation section that includes two generators and a one-way clutch (also called a sprag clutch) may be disposed on the digital book so that only one of the generators performs power generation according to a rotation direction of the lower unit.

Note that a shape of a member that can freely rotate with respect to the upper unit is not limited to the same shape as the upper unit. For example, a shape of the member (hereinafter, appropriately referred to as a rotating member) that can freely rotate with respect to the upper unit may be a disk shape.

FIG. 12A is an outline diagram illustrating a configuration example of a digital book in which a rotating member is disposed on the back surface side. FIG. 12B is an outline diagram illustrating a configuration example of the digital book that includes a rotating member which is disposed inside a housing and of which a part is exposed to outside. For example, in the digital book 21B illustrated in FIG. 12A, the rotating member 28d is disposed on the back surface side of the housing 27D of the digital book 21B. According to the configuration example illustrated in FIG. 12A, a user can perform input operations for page-turning with only a fingertip while holding the digital book 21B in one hand.

Alternatively, as illustrated in FIG. 12B, for example, a rotating member 29d may be disposed inside a housing 27E of the digital book 21C and a part of the rotating member 29d may be seen from a cutout part provided in the housing 27E. In this case, a user can exert force for rotating the rotating member 29d on the part of the rotating member 29d.

### [Third Configuration Example of the Digital Book]

FIG. 13A is an outline diagram illustrating a third configuration example of the digital book. FIG. 13B is an outline diagram illustrating a configuration example of the digital book in which a track ball is disposed in one part of a housing.

In the digital book 31A, a cylindrical dial (hereinafter referred to as a jog dial) 39J that freely rotates is disposed in a part of a housing 37A as illustrated in, for example, FIG. 13A. In addition, inside the digital book 31A, a generator 35J that generates electric power according to rotation of the jog dial 39J is disposed. The jog dial 39J is preferably disposed close to a part which the thumb of a user reaches, or close to a part which the index finger of the user reaches when the user holds the digital book 31A. This is so that the user can easily perform input operations for page-turning even when the user holds the digital book 31A in one hand.

Since the generator that performs power generation according to rotation of the jog dial when, for example, the user rotates the jog dial is disposed inside the digital book, the generator performs power generation due to rotation operations of the jog dial performed by the user. Thus, the digital book performs power generation from the rotation operations of the jog dial by the user, thereby obtaining electric power necessary for re-writing information displayed on the display unit.

Here, two directions are considered as directions in which the jog dial rotates. Thus, an input operation for forward-turning and an input operation for backward-turning can correspond respectively to the two rotation directions of the jog dial.

As illustrated in FIG. 13B, a track ball may be disposed in a part of a housing instead of the jog dial. In the configuration example illustrated in FIG. 13B, a track ball 39T is disposed in a part of a housing 37B of the digital book 31B. Inside the digital book 31B, a generator 35T that performs power generation according to rotation of the track ball 39T is disposed.

### [Fourth Configuration Example of the Digital Book]

FIG. 14A is a plan view showing a fourth configuration example of the digital book. FIG. 14B is a schematic diagram illustrating a cross-section cut along the line XIV-XIV of the digital book. FIG. 14C is a back-side view of the digital book shown in FIG. 14A.

As illustrated in FIGS. 14A to 14C, the digital book 41 includes, for example, at least two rollers disposed in parallel inside a housing 47. The housing 47 is constituted by, for example, an upper unit 47u on which the display unit 3 is disposed and a lower unit 47b disposed facing the upper unit 47u. In the configuration example illustrated in FIGS. 14A to 14C, the roller 42a and the roller 42b are disposed between the upper unit 47u and the lower unit 47b so that rotation axes thereof are disposed in parallel with the right-left direction of the digital book 41. In addition, inside the digital book 41, a generator 45 that performs power generation according to rotation of the roller 42a or the roller 42b is disposed.

In addition, on the outer side of the roller 42a and the roller 42b, a belt 44 that moves in linkage with rotation of the roller 42a and the roller 42b is wound. A part of the belt 44 is exposed from, for example, an opening Ap provided on the back surface side (on the lower unit 47b side) of the housing 47 of the digital book 41. Thus, a user can directly touch the part of the belt 44 on the back surface side of the housing 47 of the digital book 41.

When the user causes the roller 42a and the roller 42b to rotate by, for example, moving the belt 44, the generator 45 performs power generation since the generator 45 that performs power generation according to rotation of the roller 42a or the roller 42b is disposed inside the digital book 41. Thus, the digital book performs power generation due to the moving operation of the belt by the user, thereby obtaining electric power necessary for re-writing of information displayed on the display unit.

Two directions are considered as directions in which the belt is moved (directions in which the rollers disposed inside the housing are rotated). Thus, an input operation for forward-turning and an input operation for backward-turning can correspond respectively to rotation directions of the rollers. When a combination of the rollers and the belt is used, higher voltages can be obtained from input operations of the user than when the jog dial is rotated.

### [Fifth Embodiment Example of the Digital Book]

FIG. 15A is an outline diagram illustrating a fifth configuration example of the digital book. FIG. 15B is a schematic diagram illustrating a cross-section perpendicular to the center axis of a cylindrical shape of a housing. FIG. 15C is an outline diagram for describing an example of an image displayed on the back surface side of the digital book.

As illustrated in FIGS. 15A and 15B, the digital book 51 has a housing 57 formed in, for example, substantially a cylindrical shape, and a display unit 53 that is disposed so as to be wound around the outer circumferential face of the housing 57 with flexibility. In addition, inside the digital book 51, a generator or a power generation element that performs power generation according to rotation of the display unit 53 is disposed. The display unit 53 is set to, for example, freely rotate in the upper-lower direction or the right-left direction of a screen with respect to the housing 57. Note that a cylindrical center axis of the housing 57 may be parallel to the upper-lower direction of the screen, or may be parallel to the right-left direction of the screen.

The digital book 51 has a generator 55 between, for example, the display unit 53 and the housing 57 as illustrated in FIG. 15B. The generator 55 included in the digital book 51 performs power generation using relative motions of the display unit 53 and the housing 57.

If, for example, an electret is disposed on a rear surface of the display unit 53 (a surface facing the housing 57) and a conductor substrate is disposed on the outer circumferential face of the housing 57, electric power can be generated from electrostatic induction by rotating the display unit 53 with respect to the housing 57 along the outer circumferential face of the housing 57. If the electret and the conductor substrate are replaced by a magnet and a coil, electric power can be generated from electromagnetic induction.

A power generation element may be disposed between the display unit 53 and the housing 57 instead of or together with the generator. For example, if a piezoelectric element is disposed between the display unit 53 and the housing 57, force can be set to be exerted on the piezoelectric element when a user rotates the display unit 53, and accordingly, electric power is generated due to a piezoelectric effect. Further, if a thermoelectric transducer is disposed between the display unit 53 and the housing 57, for example, thermoelectric generation using frictional heat generated according to rotation of the display unit 53 is possible.

When the user rotates the display unit with respect to the housing, for example, the power generation element or the generator performs power generation due to the rotation operation of the display unit by the user since the power generation element or the generator that performs power generation according to rotation of the display unit is disposed inside the digital book. Thus, the digital book performs power generation from the rotation operation of the display unit by the user, thereby obtaining electric power necessary for re-writing information displayed on the display unit.

Note that, according to the configuration described above, a series of information that continues in one direction can also be seamlessly displayed. In addition, according to the configuration described above, among images displayed on the display unit 53, for example, content that the user desires can be displayed on the side facing the user, in other words, on the display side of the digital book 51, and other information can be displayed on the back surface side of the digital book 51. As illustrated in FIG. 15C, for example, an advertisement can be displayed on the back surface side of the digital book 51 when the user uses the digital book 51. Alternatively, on the back surface side of the digital book 51, a picture, or the like that the user designates can also be displayed.

### [Sixth Configuration Example of the Digital Book]

FIG. 16A is a plan view showing a sixth configuration example of the digital book. FIG. 16B is a schematic diagram illustrating a cross-section cut along the line XVI-XVI of the digital book. FIG. 16C is a plan view showing the digital book after forward-turning is performed. FIG. 16D is a plan view showing the digital book after backward-turning is performed.

The digital book 61 has an upper unit 67u on which the display unit 3 is disposed and the lower unit 67b, and the lower unit 67b is disposed so as to overlap the upper unit 67u as illustrated in, for example, FIGS. 16A and 16B. In other words, in the configuration example illustrated in FIGS. 16A and 16B, the upper unit 67u on which the display unit 3 is disposed and the lower unit 67b disposed facing the upper unit 67u constitute a housing 67.

As illustrated in FIG. 16B, the upper unit 67u and the lower unit 67b are connected to each other via a slide mechanism constituted by a pair of, for example, a guide rail 69a and a guide rail 69b. Thus, the lower unit 67b is set to be able to be deviated in parallel with the upper unit 67u in the left direction or the right direction thereof. In addition, inside the digital book 61, a generator 65 that performs power generation according to sliding of the lower unit 67b with respect to the upper unit 67u is disposed.

As a method of power generation, any of an electrostatic type, an electromagnetic type, a reverse magnetostrictive type, a piezoelectric type, and the like may be possible, however, since the lower unit makes linear movement with respect to the upper unit, a generator that uses, for example, an electret is preferable for the generator 65. This is because the configuration enables the generator to be lightweight. In the configuration example illustrated in FIG. 16B, the generator 65 is constituted by a conductive substrate 62 fixed to the upper unit 67u and an electret 64 fixed to the lower unit 67b facing the conductive substrate 62.

As illustrated in FIG. 16C, when a user slides the lower unit 67b to the right side of the upper unit 67u of the digital book 61, for example, the generator 65 performs power generation from the sliding operation of the lower unit 67b by the user since the generator 65 is disposed between the upper unit 67u and the lower unit 67b. Thus, the digital book performs power generation through the sliding operation of the lower unit by the user, thereby obtaining electric power necessary for re-writing information displayed on the display unit. Note that it is necessary for the slid lower unit to return to the original position, however, the power generation unit can also perform power generation through the movement of the lower unit to the original position.

An input operation for forward-turning and an input operation for backward-turning can correspond respectively to, for example, a movement of the lower unit in the right direction and a movement thereof in the left direction of the upper unit of the digital book. In other words, whether page-turning that the user intends is forward-turning or backward-turning can be determined, for example, based on the polarity of a voltage generated by the generator. As illustrated in FIG. 16D, for example, when the user slides the lower unit 67b to the left side of the upper unit 67u of the digital book 61, backward-turning is performed.

### [Seventh Configuration Example of the Digital Book]

FIG. 17A is an outline diagram illustrating a use state of the digital book. FIG. 17B is a plan view showing a configuration example of the digital book that has two respective pairs of rolls and sheets, and generators.

The digital book 71A has a roll 76R and a sheet 76S wound around the roll 76R inside a housing 77 as illustrated in, for example, FIG. 17A. One end of the sheet 76S is fixed to, for example, the roll 76R, and the other end of the sheet 76S is set to be drawn to the outside of the housing 77 through an opening provided in the housing 77. Note that, instead of the sheet, a ribbon, a rope, or the like may be used.

The roll 76R, for example, freely rotates about a rotation axis parallel in the upper-lower direction of the digital book 71A, and rotates according to winding and drawing of the sheet 76S. In addition, inside the digital book 71A, a generator 75 that performs power generation according to rotation of the roll 76R is disposed.

As illustrated in FIG. 17A, a user can draw one end of the sheet 76S to the outside of the housing 77 in, for example, the direction indicated by the arrow S shown in FIG. 17A. When the user draws one end of the sheet 76S to the outside of the housing 77, for example, the generator 76 performs power generation since the generator 75 that performs power generation according to rotation of the roll 76R is disposed inside the digital book 71A. Thus, the digital book performs power generation from the drawing operation of the sheet by the user, thereby obtaining electric power necessary for re-writing information displayed on the display unit. Note that, due to resilience of a coil spring or the like disposed inside the roll, the sheet which is drawn to the outside of the housing is set to be automatically wound around the roll when there is no longer force of drawing the sheet. Thus, the generator disposed inside the digital book can perform power generation even during winding of the sheet.

Correspondence of a drawing operation of the sheet by the user to an input operation for forward-turning and backward-turning is simple when at least two pairs of rolls and sheets, and generators are provided in the digital book as illustrated in, for example, FIG. 17B. A digital book 71B illustrated in FIG. 17B is an example of a digital book that has two pairs of rolls, sheets, and generators. In other words, the digital book 71B has rolls 76Ra and 76Rb, sheets 76Sa and 76Sb wound around the rolls 76Ra and 76Rb, respectively, and generators 75a and 75b that perform power generation according to rotation of the rolls 76Ra and 76Rb inside a housing 77D. Whether page-turning that the user intends is forward-turning or backward-turning can be determined based on, for example, which generator among the two generators performs power generation.

### [Eighth Configuration Example of the Digital Book]

FIG. 18A is an outline diagram illustrating an eighth configuration example of the digital book. FIG. 18B is an outline diagram illustrating the digital book after page-turning is performed.

The digital book 81 has, for example, a housing 87 that has flexibility and a display unit 83 that also has flexibility, and accordingly, the digital book 81 is configured to be able to bend as a whole as illustrated in FIGS. 18A and 18B. In addition, inside the digital book 81, a power generation layer 85 that performs power generation as the digital book 81 warps is disposed.

As the power generation layer 85, for example, a layer formed of a piezoelectric material, a layer formed of a material that causes electrostatic polarization such as an artificial muscle (Electroactive Polymer Artificial Muscle (EPAM)), a polymer actuator, or the like, a power generation layer formed of a combination of a magnetostrictive material and a thin-film coil (a coil formed of a metal thin film, or the like), and the like are exemplified. An artificial muscle is an element formed such that electrodes that can extend and contract are formed on both surfaces of a sheet-like elastomer.

As illustrated in FIG. 18B, when a user bends the digital book 81 while grasping, for example, the right end side and the left end side of the digital book 81, the power generation layer 85 performs power generation through the bending operation of the digital book 81 by the user since the digital book 81 has the power generation layer 85. Thus, the digital book performs power generation through the bending operation of the digital book by the user, thereby obtaining electric power necessary for re-writing information displayed on the display unit.

An input operation for forward-turning and an input operation for backward-turning can correspond respectively to, for example, bending the digital book in the horizontal direction and bending the digital book in the vertical direction. Alternatively, the operations can correspond respectively to, for example, bending the digital book on the surface side (the side of the display unit facing the user) as a contraction direction and bending the digital book on the surface side as an extension direction.

In addition, a power generation layer for obtaining electric power necessary for re-writing information in forward-turning and a power generation layer for obtaining electric power necessary for re-writing information in backward-turning may be separately formed. Whether page-turning that the user intends is forward-turning or backward-turning can be determined by performing a signal process on distribution of voltages generated in the power generation layers.

### [Ninth Configuration Example of the Digital Book]

FIG. 19A is a plan view showing a ninth configuration example of the digital book. FIG. 19B is a plan view showing the digital book after forward-turning is performed. FIG. 19C is a diagram for describing an input operation of a user for instructing backward-turning in the digital book. FIG. 19D is a plan view showing the digital book after backward-turning is performed.

The digital book 91 has, for example, a thermoelectric transducer as a power generation unit 95. A high-temperature-side contact 95Ht or a low-temperature-side contact 95Lt of the thermoelectric transducer is exposed, for example, in at least one part of the outside of a housing 97 in a direct manner or via a thermal conductor.

As a thermal conductor, for example, a heat pipe, a thermal conductive sheet, a block formed of copper or aluminum, or the like is exemplified, however, it is not limited thereto.

While using the digital book 91, when a user holds the left end side of the digital book 91 in his or her left hand, for example, to support the back face side of the digital book 91, a temperature difference is made in the digital book 91 between the part (the left end side of the digital book 91) that the user touches and a part that the user does not touch. It is assumed that, for example, the part that the user touches is warmed by the body temperature of the user, and the back face of the digital book 91 becomes warmer than the front face of the digital book 91.

At this moment, it is assumed that, for example, the high-temperature-side contact 95Ht of the thermoelectric transducer is exposed on the back face of the digital book 91 and the low-temperature-side contact 95Lt of the thermoelectric transducer is exposed on the front face of the digital book 91. Then, the thermoelectric transducer performs power generation due to the temperature difference made between the back face and the front face of the digital book 91, and the thermoelectric transducer continues the power generation while the user uses the digital book 91. Electric power obtained from the thermoelectric transducer is stored in, for example, a power storage unit 99.

As illustrated in FIG. 19B, for example, if the user further touches the back face of the digital book 91 in his or her right hand, a heat flux to the thermoelectric transducer from the user increases. In other words, an amount of power generation by the thermoelectric transducer increases. For example, by detecting an increase in a voltage generated by the thermoelectric transducer, the digital book 91 can determine that the user desires to turn a page. In this case, when the digital book 91 detects an increase in a voltage generated by the thermoelectric transducer, the digital book 91 executes re-writing of information displayed on the display unit 3 using, for example, electric power stored in the power storage unit 99.

In addition, when the user touches the front face of the digital book 91 with his or her right hand as illustrated in FIG. 19C, for example, a temperature difference between the back face and the front face of the digital book 91 is reduced. In other words, an amount of power generation by the thermoelectric transducer decreases. Also in this case, by detecting a decrease in a voltage generated by the thermoelectric transducer, the digital book 91 can determine that the user desires to turn a page.

In addition, an input operation for forward-turning and an input operation for backward-turning can correspond respectively to, for example, an increase and a decrease in the amount of power generation by the thermoelectric transducer. In other words, the user can perform an input operation of the digital book depending on what portion of the digital book the user touches. If a plurality of thermoelectric transducers are disposed in the digital book, more input operations may be set.

### [Tenth Configuration Example of the Digital Book]

FIG. 20A is a plan view showing a tenth configuration example of the digital book. FIG. 20B is a diagram for describing an input operation of a user for instructing forward-turning in the digital book.

In the digital book 101A, one coil 105c wound a sufficient number of times is disposed inside the housing 7 as illustrated in, for example, FIG. 20A.

In the tenth configuration example, a user wears, for example, a ring-like or a finger cot-like operation aid 105r on his or her finger. The operation aid 105r includes, for example, a magnet such as a rare-earth magnet that has relatively high residual magnetic flux density, or the like.

It is assumed that the user wearing the operation aid 105r moves his or her finger while, for example, bringing the operation aid 105r close to the coil 105c included inside the digital book 101A as illustrated in FIG. 20B. Then, a generator 105 is constituted by the operation aid 105r and the coil 105c, and the coil 105c generates electromotive force due to an electromagnetic induction phenomenon.

In other words, one or more coils included in the digital book function as a generator by performing relative motions with the operation aid located outside the digital book. Thus, the digital book performs power generation through so-called flicking operations by the user, thereby obtaining electric power necessary for re-writing information displayed on the display unit.

An input operation for forward-turning and an input operation for backward-turning can correspond respectively to, for example, a movement of the operation aid in the right direction and a movement thereof in the left direction with respect to the coil disposed inside the housing. In other words, whether page-turning that the user intends is forward-turning or backward-turning can be determined based on, for example, the polarity of a voltage generated by the coil disposed inside the housing.

Alternatively, the correspondence of the flicking operation by the user to the input operations for forward-turning and backward-turning is convenient when at least two coils are provided in the digital book.

FIG. 21A is a plan view showing a configuration example of the digital book that has at least two coils. FIG. 21B is a diagram for describing an input operation of a user for instructing backward-turning in the digital book.

In the digital book 101B illustrated in FIGS. 21A and 21B, for example, a coil 105ca and another coil 105cb wound a sufficient number of times are disposed inside the housing 7. Thus, whether page-turning that the user intends is forward-turning or backward-turning can be determined based on, for example, which coil between the coil 105ca and the coil 105cb shown in FIGS. 21A and 21B performed power generation. In addition, whether page-turning that the user intends is forward-turning or backward-turning may be determined by performing a signal process on distribution of voltages generated in the coils.

### <2. Second Embodiment>

### [Outlined Configuration of a Digital Book]

FIG. 22A is a plan view showing a configuration example of a digital book according to a second embodiment of the present technology. FIG. 22B is a bottom view of the digital book shown in FIG. 22A.

As illustrated in FIGS. 22A and 22B, the digital book 2 according to the second embodiment has the display unit 3, a power generation unit 6, and a housing 8 that accommodates the display unit 3 and the power generation unit 6 in common with the first embodiment. In the digital book 2, a function button F3 that assists a user with input operations, a touch sensor SE1 that senses touches of the user, and the like are disposed, if necessary.

Here, the digital book 2 according to the second embodiment has the power storage unit 9 and the power generation unit 6 includes a power generation mechanism that at least performs power generation from shaking applied to the digital book. In the second embodiment, power generation is performed even from shaking caused when a user carries the digital book, and electric power obtained therefrom is stored in the power storage unit.

### (Power Generation Unit)

The power generation unit 6 illustrated in FIG. 22A includes the power generation mechanism that at least generates electric power from shaking. As a power generation mechanism that generates electric power from shaking, for example, a generator constituted by a pair of a coil and a magnet or a magnetic fluid that freely moves inside the coil, a generator constituted by a pair of a conductive substrate and an electret that freely moves in an in-plane direction of a digital book, a generator constituted by a pair of a piezoelectric element and a metal ball that freely moves inside a digital book, or the like is exemplified. Alternatively, electric power may be obtained using a cantilever that is constituted by a piezoelectric bimorph of which one end is attached to a weight. According to the configuration described above, the power generation mechanism can generate electric power from shaking of a low frequency or irregular shaking.

### [Overview of an Operation of the Digital Book]

Since the digital book 2 has the power generation unit 6 that obtains electric power from shaking exerted on the digital book 2, when shaking is transmitted to the digital book 2 as a user carries the digital book 2, the power generation unit 6 generates voltages according to the exerted shaking. The electric power obtained from the shaking caused by the user carrying the digital book 2 is stored in the power storage unit 9.

When an input operation for activating the digital book 2 or an input operation for page-turning is performed on the digital book 2, electric power stored in the power storage unit 9 is emitted to each unit of the digital book 2 based on control of the system control unit 163. Note that, when the input operation for page-turning is performed on the digital book 2, and electric power obtained from the input operation for page-turning exceeds electric power necessary for re-writing information displayed on the display unit 3, the electric power stored in the power storage unit 9 is not consumed.

According to the second embodiment, since charging of the power storage unit is performed as the user carries the digital book, a display method that has a larger amount of power consumption for retaining a displayed image than in a toner display method or the like can be applied as a display method of the display unit. In addition, as illustrated in FIG. 22B, if a jack J1 for power output is provided in the digital book 2, the digital book 2 can also be used as a portable power source.

### [Eleventh Configuration Example of the Digital Book]

FIG. 23A is a plan view showing an eleventh configuration example of the digital book. FIG. 23B is an outline diagram illustrating the digital book after forward-turning is performed.

The digital book 111A has, for example, a generator 116 constituted by a pair of a coil 116c and a magnet 116m that freely moves inside the coil 116c in a housing 8 as illustrated in FIG. 23A. When a user puts the digital book 111A in a bag or the like and carries it, for example, shaking is exerted on the digital book 111A according to walking of the user. For this reason, the generator 116 performs power generation according to the shaking caused by the user's walking. Note that electric power generated by the generator 116 when the digital book 111A is not used is first stored in the power storage unit 9.

When the user shakes the digital book upward and downward while using the digital book, for example, the generator performs power generation according to the shaking exerting operation of the digital book by the user since the generator that performs power generation according to exerted shaking is disposed inside the digital book. Thus, the digital book performs power generation from the shaking exerting operation of the digital book by the user, and re-writes information displayed on the display unit. When electric power obtained from the shaking exerting operation of the digital book by the user is insufficient as electric power necessary for re-writing information displayed on the display unit, electric power stored in the power storage unit is used to re-write information displayed on the display unit.

In the configuration example described above, since power generation is performed as the user carries the digital book 111A, an erroneous operation of the digital book 111A is also considered when the digital book 111A is carried. Thus, the digital book is preferably provided with an erroneous operation prevention function. For example, after it is determined that the digital book is being used by the user (a first state), or not being used by the user (a second state), page-turning or the like is preferably performed.

As illustrated in FIGS. 23A and 23B, for example, a function button F3 or the like may be provided in the housing 8 of the digital book 111A and information displayed on the display unit 3 may be re-written only when the user shakes the digital book 111A while pressing the function button F3. Alternatively, the digital book 111A has the touch sensor SE1 or the like that senses contact with the user and information displayed on the display unit 3 may be re-written when, for example, electric power is generated according to inputs from the touch sensor SE1 and shaking.

Note that the digital book can preferably sense a movement direction of the digital book in a shaking exerting operation of the digital book by the user. For example, the digital book may have the sensor 165 such as an acceleration sensor or a gyro sensor so that the digital book senses a movement direction or inclination.

An input operation for forward-turning and an input operation for backward-turning can correspond respectively to a first movement direction of the digital book, for example, which is a vertically upward direction or a vertically downward direction, when the use shakes the digital book. Alternatively, when the digital book has a plurality of touch sensors, for example, a plurality of kinds of input operations may be designated according to with which touch sensor the user comes into contact.

Note that, when the digital sensor has the sensor 165 such as an acceleration sensor or a gyro sensor, whether or not the digital book is currently in a use state may be determined by analyzing inputs of the sensors and estimating a posture of the user or the digital book.

### [Twelfth Configuration Example of the Digital Book]

FIG. 24A is a plan view showing a twelfth configuration example of the digital book. FIG. 24B is a plan view showing the digital book after forward-turning is performed.

As illustrated in FIGS. 24A and 24B, the digital book may have a power generation unit that performs power generation according to shaking caused by the user carrying the digital book and a power generation mechanism that performs power generation from an input operation for page-turning.

In the digital book 121 exemplified in FIGS. 24A and 24B, the digital book 121 has a generator 126 that performs power generation according to shaking caused by the user carrying the digital book. In addition, the digital book 121 has a movable part 128ma and another movable part 128mb in a part of a housing 128.

For example, the movable part 128ma and the movable part 128mb respectively provided on the lower left side and the lower right side of the housing 128 are set to be pressed in the direction to the center of the housing 128. In addition, the movable part 128ma and the movable part 128mb are configured to return to their original positions due to a spring mechanism or the like when pressed in the direction to the center of the housing 128.

Inside the housing 128, for example, a piezoelectric element 125a and another piezoelectric element 125b are disposed respectively on a lower left side and a lower right side of the housing 128. The piezoelectric element 125a is disposed between the movable part 128ma and the center of the housing 128, and when the movable part 128ma is pressed in the direction to the center of the housing 128, force is set to be exerted on the piezoelectric element 125a. In the same manner, the piezoelectric element 125b is disposed between the movable part 128mb and the center of the housing 128, and when the movable part 128mb is pressed in the direction to the center of the housing 128, force is set to be exerted on the piezoelectric element 125b.

As illustrated in FIG. 24B, when a user exerts impact force P3 on the movable part 128mb by hitting the movable part 128mb with his or her palm, or the like, for example, force is exerted on the piezoelectric element 125b, and due to the hitting operation of the digital book 121 by the user, the piezoelectric element 125b performs power generation. Thus, the digital book re-writes information displayed on the display unit with the hitting operation of the digital book by the user as an input.

An input operation for forward-turning and an input operation for backward-turning can correspond respectively to, for example, a hitting operation of the movable part 128mb and a hitting operation of the movable part 128ma.

As described above, according to the present disclosure, since a digital book has a power generation mechanism, it is not necessary to charge a storage battery in advance before a user uses the digital book, and thus the user can use the digital book without worrying about the remaining level of the storage battery. In addition, in the present disclosure, since an active operation for giving an instruction of switching images to a digital book is associated with power generation, a user can drive the digital book without a special operation. Thus, according to the present disclosure, a digital book can realize re-writing of information displayed on a display unit with an input operation for page-turning performed by the user.

Further, according to a configuration of the present disclosure, a shape of a digital book can be a shape in which a user can easily hold the digital book in one hand, for example, a flat plate shape or the like, and it is not necessary to sacrifice a screen size of the digital book.

### <3. Modified Example>

Although exemplary embodiments have been described hereinabove, a specific exemplary embodiment is not limited to the above description, and can be variously modified.

For example, kinetic energy, heat energy, or the like generated from an operation for instructing switching of images by a user is first accumulated, and the accumulated energy may be converted into electric energy in the final stage of the instruction of switching images by the user.

FIG. 25A is a plan view showing another configuration example of the digital book. FIG. 25B is a plan view showing the digital book after forward-turning is performed.

As illustrated in FIGS. 25A and 25B, the digital book 131 has, for example, a spring mechanism 139 constituted by a spiral spring 139f, and the like, and a lever 138R and a stopper 138S which are exposed to the outside of a housing 138.

When a user slides, for example, the lever 138R, the lever 138R is held by the stopper 138S in a position after the sliding. At this moment, according to the movement of the lever 139R, the spiral spring 139f of the spring mechanism 139 is wound according to the movement of the lever 139R, and kinetic energy generated from the operation of the user is accumulated in the spiral spring 139f of the spring mechanism 139

When the user releases the stopper 138S, the energy accumulated in the spiral spring 139f is discharged, and the discharged energy is converted into electric energy by a power generation unit 135. A power generation method of the power generation unit 135 is not particularly limited, however, a method exemplified in the embodiments described above can be applied thereto. In the example describe above, release of the stopper 138S by the user corresponds to an input operation for switching images by the user. Note that, by the user releasing the stopper 138S, the lever 138R returns to the original position.

In addition, for example, the digital book may have an automatic winding mechanism of the spiral spring. This automatic winding mechanism can also be configured as, for example, a microelectromechanical system (MEMS) obtained from application of a semiconductor manufacturing technology or microminiaturization in a mechatronics technology.

When the digital book has the automatic winding mechanism, if shaking is transmitted to the digital book as a user carries the digital book, the spiral spring can be wound due to the shaking. In other words, the digital book can store energy gained from shaking exerted on the digital book in the spiral spring.

By discharging the energy stored in the spiral spring in accordance with an operation of the digital book by the user and then converting the energy into electric energy, the digital book can obtain electric power necessary for re-writing information displayed on the display unit.

In the above-described example, the function of page-turning can be realized by generating electric power in an amount necessary for re-writing information displayed on the display unit without storing electric power.

Alternatively, for example, conversion into heat energy may precede conversion from kinetic energy into electric energy. In other words, by using friction movements or using an external-combustion engine such as a Stirling engine or a thermoacoustic engine, kinetic energy is first converted into heat energy, then the heat energy is supplied to a thermoelectric transducer, a thermionic power generation element (thermionic generator), or the like, and thereby power generation may be performed.

As exemplified in the above-described embodiment, when a movement of heat is used for an input operation on a digital book such as a case when a user makes a temperature difference in a thermoelectric transducer, or the like, for example, a heat storage material can also be used as an energy storage mechanism. In other words, instead of accumulating electric energy in a storage battery, or together with accumulating electric energy in a storage battery, heat energy can also be accumulated in a heat storage material.

A digital book can obtain electric power necessary for re-writing information displayed on the display unit by discharging the heat energy stored in the heat storage material in accordance with an operation of the digital book by a user and converting the heat energy into electric energy. In the conversion from heat energy into electric energy, an external-combustion engine or an internal-combustion engine may be used.

Also in the example described above, the function of page-turning can be realized by generating electric power in an amount necessary for re-writing information displayed on the display unit without storing electric power.

Note that, if a digital book is set to have a power generation system constituted by a plurality of power generation mechanisms in each independent region, since each of the power generation mechanisms is independent, the power generation system can be stabilized.

In addition, for example, a digital book may be set to have a power transmission device that uses the electromagnetic induction phenomenon or a power transmission device using magnetic field resonance or electric field resonance. The digital book may be a display terminal equipped with a communication function.

The technology of the present disclosure can also be applied to, for example, laptop computers, mobile information terminals (personal digital assistances (PDAs)), smartphones, electronic dictionaries, electronic organizers, and the like, in addition to digital books. In addition, the technology of the present disclosure can also be applied not only to portable display devices but also to digital signage installed in buildings.

The configuration, the method, the shape, the material and the value in the above-described embodiments are merely examples, and other configurations, methods, shapes, materials and values may be used, as necessary. The configuration, method, shape, material and value of the above-described embodiments may be combined without departing from the scope and the spirit of the present disclosure.

Additionally, the present technology may also be configured as below.

(1)

A display device including:

a display unit;

a power generation unit configured to have one or more power generation mechanisms and to generate electric power necessary for re-writing information displayed on the display unit; and

a housing configured to have a substantial flat plate shape as a whole and to accommodate the display unit and the power generation unit,

wherein generation of electric power by at least one power generation mechanism among the one or more power generation mechanisms is associated with an input operation performed by a user.

(2)

The display device according to (1), wherein, among the one or more power generation mechanisms, at least one power generation mechanism generates electric power using shaking.

(3)

The display device according to (2), further including:

a power storage unit,

wherein electric power obtained by the power generation unit is stored in the power storage unit.

(4)

The display device according to any one of (1) to (3), wherein a first state and a second state are set, and the first state and the second state are switched according to whether or not the user comes into contact with at least a part of the housing.

(5)

The display device according to any one of (1) to (3), further including:

a sensor configured to sense a current movement direction or current inclination of the housing,

wherein a first state and a second state are set, and the first state and the second state are switched according to an output from the sensor.

(6)

The display device according to (5), wherein electric power obtained by the power generation unit is stored in the power storage unit in one state of the first state and the second state.

(7)

The display device according to any one of (1) to (6), further including:

a movable member configured to freely move or freely rotate with respect to the housing,

wherein, among the one or more power generation mechanisms, at least one power generation mechanism performs power generation with a relative motion between the housing and the movable member.

(8)

The display device according to (7), wherein the relative motion between the housing and the movable member is a motion made within a plane parallel with the main face of the display unit.

(9)

The display device according to any one of (1) to (6),

wherein the housing includes a first member and a second member and further includes an elastic mechanism disposed between the first member and the second member, and

wherein, among the one or more power generation mechanisms, at least one power generation mechanism performs power generation by inclining at least a part of the second member with respect to the first member.

(10)

The display device according to any one of (1) to (6), further including:

a rotator of which a part is exposed to the outside from an opening provided in the housing,

wherein, among the one or more power generation mechanisms, at least one power generation mechanism performs power generation according to rotation of the rotator.

(11)

The display device according to any one of (1) to (6), further including:

a pair of rollers; and

a belt configured to be disposed on outer circumferential faces of the pair of rollers and to freely move according to rotation of the individual rollers constituting the pair of rollers, a part of the belt being exposed to the outside from an opening provided in the housing,

wherein, among the one or more power generation mechanisms, at least one power generation mechanism performs power generation according to rotation of at least one roller among the rollers constituting the pair of rollers.

(12)

The display device according to any one of (1) to (6),

wherein the power generation unit and the housing have flexibility, and

wherein, among the one or more power generation mechanisms, at least one power generation mechanism performs power generation according to flexure applied to the power generation unit.

(13)

The display device according to any one of (1) to (6), wherein, among the one or more power generation mechanisms, at least one power generation mechanism performs power generation with a temperature difference made between a first region of the housing and a second region of the housing.

(14)

The display device according to any one of (1) to (13), wherein a signal for instruction of re-writing of information displayed on the display unit is electric power as an electric signal generated by at least one power generation mechanism among the one or more power generation mechanisms.

### REFERENCE SIGNS LIST

1,2 digital book
3 display unit
5, 6 power generation unit
8 housing
9 power storage unit

1. A display device comprising:
a display unit;
a power generation unit configured to have one or more power generation mechanisms and to generate electric power necessary for re-writing information displayed on the display unit; and
a housing configured to have a substantial flat plate shape as a whole and to accommodate the display unit and the power generation unit,
wherein generation of electric power by at least one power generation mechanism among the one or more power generation mechanisms is associated with an input operation performed by a user.

2. The display device according to claim 1, wherein, among the one or more power generation mechanisms, at least one power generation mechanism generates electric power using shaking.

3. The display device according to claim 1, further comprising:
a power storage unit,
wherein electric power obtained by the power generation unit is stored in the power storage unit.

4. The display device according to claim 2, wherein a first state and a second state are set, and the first state and the second state are switched according to whether or not the user comes into contact with at least a part of the housing.

5. The display device according to claim 2, further comprising:
a sensor configured to sense a current movement direction or current inclination of the housing,
wherein a first state and a second state are set, and the first state and the second state are switched according to an output from the sensor.

6. The display device according to claim 4, wherein electric power obtained by the power generation unit is stored in the power storage unit in one state of the first state and the second state.

7. The display device according to claim 1, further comprising:
a movable member configured to freely move or freely rotate with respect to the housing,
wherein, among the one or more power generation mechanisms, at least one power generation mechanism performs power generation with a relative motion between the housing and the movable member.

8. The display device according to claim 7, wherein the relative motion between the housing and the movable member is a motion made within a plane parallel with the main face of the display unit.

9. The display device according to claim 1,
wherein the housing includes a first member and a second member and further includes an elastic mechanism disposed between the first member and the second member, and
wherein, among the one or more power generation mechanisms, at least one power generation mechanism performs power generation by inclining at least a part of the second member with respect to the first member.

10. The display device according to claim 1, further comprising:
a rotator of which a part is exposed to the outside from an opening provided in the housing,
wherein, among the one or more power generation mechanisms, at least one power generation mechanism performs power generation according to rotation of the rotator.

11. The display device according to claim 1, further comprising:
a pair of rollers; and
a belt configured to be disposed on outer circumferential faces of the pair of rollers and to freely move according to rotation of the individual rollers constituting the pair of rollers, a part of the belt being exposed to the outside from an opening provided in the housing,
wherein, among the one or more power generation mechanisms, at least one power generation mechanism performs power generation according to rotation of at least one roller among the rollers constituting the pair of rollers.

12. The display device according to claim 1,
wherein the power generation unit and the housing have flexibility, and
wherein, among the one or more power generation mechanisms, at least one power generation mechanism performs power generation according to flexure applied to the power generation unit.

13. The display device according to claim 1, wherein, among the one or more power generation mechanisms, at least one power generation mechanism performs power generation with a temperature difference made between a first region of the housing and a second region of the housing.

14. The display device according to claim 1, wherein a signal for instruction of re-writing of information displayed on the display unit is electric power as an electric signal generated by at least one power generation mechanism among the one or more power generation mechanisms.
